(19) United States
(12) Patent Application Publication
(10) Pub. No.: US 2025/0018992 A1
(43) Pub. Date: Jan. 16, 2025

(54) PUSHABLE TRANSPORT CART SYSTEM

(71) Applicant: EXPRESSO Deutschland GmbH & Co. KG, Kassel (DE)

(72) Inventors: Claudius Wilhelms, Kassel (DE); Uwe Vellmer, Meinhard (DE); Eduard Kamzin, Vellmar (DE); André Hildmann, Kassel (DE)

(73) Assignee: EXPRESSO Deutschland GmbH & Co. KG, Kassel (DE)

(21) Appl. No.: 18/771,835

(22) Filed: Jul. 12, 2024

(30) Foreign Application Priority Data
Jul. 14, 2023 (DE) 10 2023 118 739.2

(51) Int. Cl. B62B 5/00; B62B 3/14; B62B 5/04; G06Q 30/06; H01R 13/24; H02J 7/00

(52) U.S. Cl. CPC B62B 5/0053; B62B 3/14; B62B 5/04; B62B 5/0096; G06Q 30/06; H01R 13/24; H02J 7/007188

(57) ABSTRACT

The invention relates to a first pushable transport cart which can be embodied as a shopping cart or baggage cart. The first pushable transport cart comprises contact elements. If the first pushable transport cart is pushed into a second corresponding pushable transport cart, the contact elements form an electric contact between the first and second pushable transport carts. Electric power can be supplied via this electric contact, whereby charging of a storage device of the first pushable transport cart from a storage device of the second pushable transport cart takes place using a charge flow management system.

### CROSS REFERENCE TO RELATED APPLICATIONS

This application claims priority to co-pending German Patent Application No. DE 10 2023 118 739.2 filed Jul. 14, 2023, the disclosure of which is hereby incorporated herein by reference in its entirety.

### FIELD OF THE INVENTION

The invention relates to a pushable transport cart system with at least two pushable transport carts.

The pushable transport cart is preferably a shopping cart, such as those used in stores, food markets or shopping centers, or a baggage cart, such as those used in travel centers, e.g. railroad stations, airports or hotels. In general terms, the invention can be used in any pushable transport cart which stands on the floor via rollers, can be pushed manually by a user via a handling device such as a handle or a push bar and on or in which objects such as shopping goods or items of baggage can be arranged and transported for transportation.

Modern pushable transport carts are equipped with electric devices that require an electric power supply via an electric cable for operation. If the pushable transport cart is to be able to be moved autonomously with the electric device without being connected to a cable, the pushable transport cart must be equipped with an electric storage unit as an accumulator that supplies the electric device with electric power. Such an electric storage device must be recharged again and again.

### BACKGROUND OF THE INVENTION

Publications US 2006/0254861 A1, GB 2498509A and WO 2013/092258 A1 disclose pushable transport cart systems with several pushable transport carts that can be manually connected to each other and/or to a stockage station for pushable transport carts by a user via a mechanical connecting element embodied as a securing chain. The connecting element simultaneously creates an electric connection between the pushable transport cart and a charging device of the stockage station or a mains supply. Via the electric connection, an energy storage device of the pushable transport cart is charged by the charging device or the electric mains supply.

Publications CN 206569113 U and U.S. Pat. No. 11,465,663 B2 disclose pushable transport cart systems that have rigid contact elements arranged in such a way that a mechanical connection and an electric contact are established simultaneously when the pushable transport carts are pushed into one another or into a charging station without the intervention of a user. An energy storage device of a pushable transport cart can be charged by the charging station via the electric contact.

### SUMMARY OF THE INVENTION

The object of the invention is to propose a pushable transport cart system, which is improved in particular with regard to
an electric power supply and/or
electric contacting and/or
a supply, return and/or transmission of electric signals and/or
a load, consumption and charging management system.

The invention relates to a pushable transport cart system with at least two pushable transport carts. The pushable transport cart is in particular a shopping cart or baggage cart pushed manually by a user. In the following, reference is preferably made in part to a shopping cart, although the same can also apply to a baggage cart or any other pushable transport cart. The pushable transport cart comprises an electric device, wherein such an electric device may also comprise an electronic device with an electronic control unit or CPU. To give only a few non-limiting examples of the invention, the electric device may be or comprise
measurement technology, in particular a sensor (for example a temperature sensor, a sensor for detecting the mass of an object arranged on or in the shopping cart or baggage cart, an acoustic sensor for detecting environmental noise or rolling noise of the pushable transport cart, a scanner for detecting a contour of the product or baggage or for detecting characteristic data of the product or baggage or a marking, in particular a barcode or QR code) and/or
processing electronics for the measurement technology and/or
uni- or bidirectional wireless or wired communication devices (e.g. for updating the control logic of an electronic control unit of the pushable transport cart, for transferring parameters to the pushable transport cart or for transmitting measured or operating variables from the pushable transport cart to other components of the pushable transport cart system or for uni- or bidirectional communication with a portable, network-compatible electronic device of the user) and/or
locking systems operated by means of an electric actuator for securing the pushable transport cart relative to an adjacent pushable transport cart or relative to a storage and/or charging station and/or
an electronic control unit and/or
a drive system of the pushable transport cart that supports a pushing force applied by the user.

Alternatively or cumulatively, the pushable transport cart has an electric storage device, which may be an electric accumulator, in particular a chemical storage device of any design (lithium-ion storage device, sodium-ion storage device, lead storage device, LiFePo4 storage device), and/or an electric capacitor or supercapacitor. The electric storage device may then be connected to the electric device in order to supply it with electric power and thus also enable self-sufficient operation of the pushable transport cart.

For one embodiment the pushable transport cart comprises (at least) two contact elements, which are also referred to below as “first contact element” and “second contact element”. The contact elements are embodied as and arranged on the pushable transport cart in such a way that a first contact element of the pushable transport cart forms an electric contact with the second contact element of the second pushable transport cart in a motion-controlled manner by an insertion movement of this pushable transport cart into a second, corresponding and preferably identically designed pushable transport cart. Two pushable transport carts can be inserted into each other in this way if at least two pushable transport carts are pushed into each other to form a row or line in order to arrange them compactly and possibly also move them together. Furthermore, such an insertion of pushable transport carts into one another can take place in the area of a storage and/or charging station. A simple establishment of electric contact between the two pushable transport carts can be ensured “automatically” if the pushable transport carts are pushed into one another as required anyway. The electric contact established in this way can serve for a variety of purposes. For example, electric signals can be transmitted between the two pushable transport carts via the electric contact. It is also possible for electric power to be transmitted via the electric contact to charge the electric storage device and/or for electric power to be passed on via several pushable transport carts pushed into one another in this way.

The pushable transport cart system comprises control logic that provides a charge flow management in which a storage device of a pushable transport cart is charged from a storage device of at least one other pushable transport cart. The control logic may control an exchange of electrical energy between pushable transport carts by the electrical connection devices or by the contact elements, which are connected to each other but not to a storage and/or charging station. Thereby a higher charge level of a pushable transport cart can be used to partially charge at least one other pushable transport cart with a lower charge level. In the simplest case, the charge levels of the pushable transport carts connected to each other in the line are equalized to the same averaged charge level. It is also possible that the control logic ensures that a storage device providing the electrical power is only discharged to a minimum predetermined charge level, which is dimensioned so that the minimum charge level ensures the continued operation of the pushable transport cart (at least for a reduced operating time). However, it is also possible, for example, that the control logic preferably prioritizes pushable transport carts that are further away from the charging station in such a way that electrical power is transferred to them from storage units further away from the charging station, as the pushable transport carts receiving power from a storage unit in this way are more likely to be used by a user in the near future. It is also possible that, in the event that at another time at least some of the line of interconnected pushable transport carts are connected to the storage and/or charging station, the control logic brings about and/or controls or regulates a superimposition of the electrical power supply by the charging station with the equalization of energy between the individual storage units.

The electric contact can be brought about when a defined insertion position is reached. For one proposal, a compensating device is provided. The compensating device ensures that the electric contact is not exclusively established for optimum insertion of the pushable transport carts into one another. Rather, the compensating device ensures that an electric contact is established in a compensation range with different relative positions between the pushable transport carts pushed into one another. These different relative positions can alternatively or cumulatively comprise the following different relative positions:
a) The compensating device can ensure an electric contact for different relative positions of the pushable transport carts in the longitudinal direction of the pushable transport carts. The compensating device can thus provide a longitudinal compensation area in which an electric contact is established. For example, the longitudinal compensation range ensures longitudinal compensation in a range of 2 cm to 50 cm, 4 cm to 40 cm or 6 cm to 25 cm. Preferably, this longitudinal compensation range begins with the ideal complete insertion position of the pushable transport carts into one another.
b) It is also possible that the compensation range is a transverse compensation range that enables an electric contact to be established also when the two pushable transport carts are pushed into each other with a transverse offset of the longitudinal axes. In this case, the transverse compensation range can, for example, enable a transverse compensation of more than 0 cm to less than 10 cm, less than 8 cm or less than 5 cm on both sides of an ideal insertion position of the pushable transport carts into each other with coaxial longitudinal axes.
c) It is also possible that the compensating device provides an angular compensation range which ensures electric contact even if the two pushable transport carts are pushed into each other at an angle of the longitudinal axes on both sides of the relative position with an ideal insertion of the pushable transport carts with coaxial longitudinal axes, which is greater than 0° and less than 25°, less than 20°, less than 15° or less than 10°.
d) It is also possible that the compensating device ensures a height compensation.

Preferably, the compensating device ensures at least both a longitudinal compensation range and a transverse compensation range as well as an angular compensation range.

There are many different ways of designing the compensating device. For one proposal, at least one contact element itself is embodied as resilient, so that an electric conductor forming the contact element itself comprises an elasticity which is used to provide the compensation range. Alternatively or cumulatively, it is possible for the contact element to be resiliently supported via a spring device, in which case the contact element can be contacted via a cable which can compensate for the resilient movement of the contact element.

There are various options for the resilient degree of freedom of the contact element.

For one variant, the contact element is embodied as resilient or resiliently supported in a horizontal direction (preferably in the transverse direction, in the longitudinal direction or in any angled horizontal direction of the pushable transport cart). When the pushable transport carts are pushed into one another, the contact element can therefore deflect in a horizontal direction, for example in the transverse or longitudinal direction of the vehicle, in order to provide the compensation range.

Alternatively or cumulatively possible for a variant is that the contact element is embodied as resilient in a vertical direction or is resiliently supported in a vertical direction. In this case, a first contact element of a first pushable transport cart can be driven over or under by a second contact element of a second pushable transport cart with the insertion, wherein at least one of the contact elements can also be embodied as a ramp. The contact element can yield resiliently in the vertical direction when it is moved over or under.

In one embodiment it is also proposed that at least one contact element is embodied as a contact slide bar. If a first contact element of a first pushable transport cart is formed as a contact slide bar, the second contact element of the second pushable transport cart can slide along the contact slide bar when it is pushed in. In this case, the second contact element can be embodied as resilient or supported resiliently, while the contact slide bar is firmly attached to the pushable transport cart. Alternatively or cumulatively, however, the contact slide bar can also be embodied as resilient or supported resiliently. The sliding path of the contact element along the contact slide bar can provide a compensation range. In this case, an additional compensation range can be provided by the resilient design or support of the other contact element.

The resiliently embodied or supported contact element may not be preloaded, which leads to the consequence that when this contact element is moved in the direction of the other contact element of the second pushable transport cart, a contact force increasing from zero with further movement is brought about. However, it is also possible that the contact element is pretensioned in such a way that the contact force increases from a pretension value with further movement as the contact elements touch each other and continue to move relative to each other.

The contact elements can be arranged anywhere on the pushable transport cart. For one proposal, at least one contact element is arranged on a chassis frame. On the one hand, the chassis frame ensures good support of the contact element, as the chassis frame is designed to support the pushable transport cart via the vehicle wheels and is also robust for absorbing the forces in the event of a possible collision of a pushable transport cart with the surroundings. If the chassis frame and the contact element arranged thereon are located at a low height (in particular less than 30 cm, less than 25 cm or less than 20 cm) above the ground, the contact element is arranged outside the area in which it is highly likely to come into interaction with the user. Any such interaction can be disadvantageous, for example, if the contact element is subjected to currents or voltages that are unpleasant or harmful to the user's health.

Preferably, the arrangement of the at least one contact element on the chassis frame is used for a special embodiment of the pushable transport cart, in which at least one transport device is supported on the chassis frame via load cells. If the pushable transport cart is a shopping cart, the transport device can be a shopping article storing device, in particular a shopping cart basket, and/or a shopping article storing platform, in particular a placement platform for beverage crates, whereby these shopping article storing devices can also be held via a shopping article storing frame, which is then supported on the chassis frame via the load cells. With regard to possible such embodiments of the pushable transport cart with transport devices supported on the chassis frame via load cells, reference is made in particular to patent DE 10 2018 132 059 B1 of the applicant, the disclosure of which is made the subject of the present patent application.

There are many options for the design of the chassis frame. To mention just one non-limiting embodiment, the chassis frame can comprise a U-shaped frame structure. The opening of the U can be used for pushing the pushable transport carts into one another. The U-shaped frame structure comprises a base leg and two side legs. The base leg is arranged in the front end area of the pushable transport cart. In contrast, the side legs extending from the base leg diverge towards the rear. When the chassis frames of two pushable transport carts are pushed in, the side legs of the rear pushable transport cart converging in the direction of insertion enter the rearwardly diverging side legs of the front pushable transport cart, which can create a certain centering and guiding effect. The U-shaped frame structure can be oriented horizontally or inclined at an angle, for example less than 20° or less than 10°, relative to the horizontal.

When using such a U-shaped frame structure, it is possible that a (first) contact element is arranged on an outer side of a side leg, while a (second) contact element is arranged on an inner side of the same side leg. In this way, it can be ensured that the two contact elements form an electric contact when two pushable transport carts are pushed into each other when the corresponding side legs of the two pushable transport carts approach each other. In this case, the two contact elements on a pushable transport cart can be arranged offset to each other in the longitudinal direction of the side leg. This offset can correspond to the offset of the longitudinal axes of the pushable transport carts in the pushed-in position (here, a compensation range can also be provided).

Alternatively or additionally, a contact element (preferably two contact elements) is arranged in the area of the base leg. In this case, a contact element can have a contact surface comprising a surface normal in the direction of the longitudinal axis of the pushable transport cart and pointing forwards or backwards. It is also possible for the contact element to comprise a contact surface whose surface normal is oriented in a vertical direction. However, any other orientation of the contact surface of the contact element is also possible. The orientation can also change with a deflection of the contact element. In this case, the arrangement of the contact element “in the area of the base leg” means that the contact element is attached directly to the base leg. However, it is also possible that this means that the contact element is attached at a distance to the base leg or to another component of the pushable transport cart, provided that the contact element does not comprise a greater distance from the base leg than the distance between the two base legs of two pushable transport carts when they are fully inserted into each other. If a first contact element and a second contact element are arranged in this way in the area of the base leg, these two contact elements can form an electric contact when the pushable transport carts are pushed in. For this embodiment, one contact element can comprise a downward-facing contact surface and the other contact element can comprise an upward-facing contact surface.

One embodiment relates to the integration of the electric storage device and/or the electric device in the pushable transport cart for this configuration of the contact elements. It is proposed that the electric storage device and/or the electric device are/is arranged in a longitudinal section, which is located between the contact element with the downward-facing contact surface and the contact element with the upward-facing contact surface. On the one hand, this leads to a compact integration of these components into the pushable transport cart. Under certain circumstances, a short electric line connection between the contact elements and the electric storage unit and/or the electric device can also be ensured in this way.

It is possible that a first contact element and a second contact element are provided on the pushable transport cart, which can be used, for example, to transmit electric power or an electric signal. It is also possible that redundant electric contact elements are provided, wherein it is possible that a first contact element is provided redundantly, while the second contact element is only provided once, or both contact elements are provided redundantly. On the one hand, the redundant contact elements can increase reliability by using the redundant other contact element in the event of a defect in one contact element. However, it is also possible for the redundant contact elements to come into effect for different insertion positions of the pushable transport carts, so that the redundant contact elements can also be used to form a compensating device whose compensation range results from the sum of the compensation ranges of the two redundant contact elements. It is possible that at least one pair of contact elements is present, which in this case can form redundant contact elements or can be used to transmit different signals. It is also possible that in the pair of contact elements, one contact element is used as a supply or feeding line in an electric circuit, while the other contact element of the pair of contact elements is used as a return line of the electric circuit. To give only some non-limiting examples, the pair of contact elements may be embodied as a kind of double tongue or a double contact slide bar.

A structural element comprising an interior space may be present in a pushable transport cart. This structural element can be a frame element, a profile element, a support frame or similar. The interior space may comprise an edge-closed cross-section or be slotted or have any desired opening. In this case, a cable can extend through the interior space of the structural element. In this case, the cable can extend from one of the contact elements and, for example, be connected to the electric storage and/or the electric device, lead to another location such as a handling device or serve to connect another pushable transport cart via further contact elements.

In one proposal, the contact element is adjustable. It is possible that the position of the contact element, at which the contact element is arranged on the pushable transport cart, in particular a chassis frame, can be adjustable in order to be able to adjust the relative position of the pushable transport carts pushed into one another, in which the electric contact is established. Alternatively or cumulatively, the contact element can be adjustable in terms of its orientation. Alternatively or cumulatively, the contact element can be adjustable in terms of its elasticity, for example in order to adjust the contact force produced on the contact elements when the pushable transport carts are pushed into one another and/or to influence the thrust forces applied by the user to generate the contact force. Alternatively or cumulatively, it is possible that the pretension of the contact element, the elasticity and/or the spring constant of a resilient support are/is adjustable.

One embodiment is explained below for the design of the pushable transport cart as a baggage cart. Such a baggage cart may comprise a fixing brake. In principle, the fixing brake can be applied via a spring device to a parking position in which the fixing brake is actuated. In this way, the baggage cart can be secured against rolling away. If the user wishes to move the baggage cart, the fixing brake can then be moved manually from the parked position to a release position. This is usually done by manually actuating a release element, which is arranged in the area of a handling device of the baggage cart. This release device is preferably embodied as a manually pivotable pushrod of the baggage cart, by which the user pushes the baggage cart. If the user swivels the pushrod downwards, the fixing brake is released. In order to enable several interlocking baggage carts to be pushed together if the user only presses down the pushrod of the last baggage cart, the fixing brake is automatically transferred to the release position when the baggage carts are pushed into each other. For this purpose, the pushable transport carts comprise an actuation element which can be moved into a release position by the push-in movement of the pushable transport cart into a second corresponding pushable transport cart against the action of the spring device. This movement of the actuation element is kinematically coupled with the actuation of a braking element of the fixing brake, which is pressed against a vehicle wheel in the park position and is arranged at a distance from the vehicle wheel in the release position. Examples of such baggage carts with a fixing brake are described in the applicant's patent DE 10 2005 003 730 B4, the disclosure of which is made the subject of the present patent application. In one embodiment at least one contact element is arranged on the actuation element for the fixing brake. In this way, the contact of the actuation element of a pushable transport cart with an actuation surface of another pushable transport cart, which also comprises a contact element, can be used multifunctionally, namely on the one hand for releasing the fixing brake and on the other hand for establishing the electric contact. In this case, even the spring device that acts on the actuation element can be used multifunctionally, as it not only serves to provide the fixing brake effect, but also ensures the contact force for the contact element.

The actuation element can be embodied as a pivoting lever, wherein for example the lever length and/or the kinematic connection of the actuation element to the braking element can also be used to specify a desired ratio of the contact force on the one hand and the locking braking force on the other hand.

The pushable transport cart can also have a mechanical connecting device. The pushable transport cart can be mechanically connected to another pushable transport cart and/or a stockage and/or charging station via the mechanical connecting device. Without this necessarily being the case, the mechanical connecting device can be used to lock the pushable transport cart at a parking location, in particular in the area of the stockage and/or charging station, whereby a more or less large locking force or securing force can be provided by the mechanical connecting device. For conventional shopping carts, the mechanical connecting device is often embodied as a securing chain of a pushable transport cart, whereby the securing chain then comprises a plug-in tongue at the end, which can be inserted into a corresponding plug socket of an adjacent pushable transport cart. The plug-in tongue can then be secured in the plug socket via a coin-operated lock, which ensures that the pushable transport cart can only be removed by inserting a coin into the coin-operated lock and the user is required to reconnect the pushable transport cart to another pushable transport cart or the stockage and/or charging station after use in order to retrieve the coin from the coin-operated lock. The mechanical securing device is preferably attached directly or indirectly to a handling device such as a handle or a pushrod oriented in the transverse direction of the pushable transport cart, by which the user pushes the pushable transport cart.

The mechanical connecting device can be used multifunctionally. For this purpose, the mechanical connecting device and an electric connecting device are combined, the electric connecting device preferably being integrated into the mechanical connecting device. The mechanical connecting device and the electric connecting device are configured in such a way that when the mechanical connecting device is mechanically connected to the mechanical connecting device of an adjacent pushable transport cart or the stockage and/or loading station, at least one electric connection is created between the electric connecting device and an electric connecting device of the other pushable transport cart or the stockage and/or loading station. This electric connection can then be used to exchange electric power and/or signals and/or data between the two pushable transport carts. The electric power exchange can be used to change the state of charge. Here, it is possible that the electric storage device is charged via the electric connection created. However, it is also possible for the electric storage device to be discharged via the electric connection, whereby the discharged electric power is transferred to the other pushable transport cart for charging it or for transferring it to another pushable transport cart.

Any signal exchange via the electric connection created can be used to transmit a measurement signal, for example with regard to an operating variable, to exchange a specific parameter for the pushable transport cart, etc. Any data exchange via the electric connection can be used, for example, to exchange information about the charge status of the electric storage device or to exchange information about whether another pushable transport cart is connected to the pushable transport carts on a side facing away from the charging station.

It is possible that the electric contact of the contact elements (in particular in the area of the chassis frame) on the one hand and the electric connection via the electric connecting device on the other hand serve different purposes, wherein, for example, the storage device can be charged via the electric contact elements and electric signals can be transmitted via the electric connecting device (or vice versa). However, it is also possible that an electric contact of contact elements of the two pushable transport carts and the electric connection via the electric connection device serve to provide an electric circuit, so that, for example, the electric contact of the contact elements serves to connect to a first pole of a power source and the electric connecting device serves to connect to a second pole of an electric power source. The same applies to a use in a common circuit for transmitting the electric signal.

In another proposal, the mechanical connecting device comprises a securing chain. Here it is quite possible that an electric conductor of the electric connecting device is embodied as a separate device from the securing chain, but as a spatially combined device. For a particular proposal, loosely adjoining members of the securing chain form an electric conductor of the electric connecting device, wherein an additional insulation can then surround the securing chain or the members of the securing chain can comprise an insulation away from the contact points of the same. If the currents and/or voltages that are transmitted via the conductor formed by the members of the securing chain are so small that they do not lead to impairments of the user when the user comes into contact with the members of the securing chain, or if only one line branch of an otherwise closed circuit is transmitted via the members and the electric connecting device, the securing chain or the members of the securing chain can also not be insulated at all.

A coin-operated lock of a type known in principle can be present in the pushable transport cart, in which the insertion of a coin into the coin-operated lock is required to release the mechanical connecting device. However, it is also possible for any other mechanical securing, latching and locking device to be used. Here, it is also possible, for example, for a lock operated by means of an electric actuator to be used, which can be operated by a user by means of a portable, network-compatible electronic device (in particular a smartphone by means of an app of the person or company who runs the shopping center).

There are many possibilities for the design of the connecting devices of the pushable transport cart, some of which are also known from the prior art. For one proposal, the mechanical connecting device comprises an electric conductive plug-in tongue and a plug socket. A plug-in tongue of a pushable transport cart can then be plugged into the plug socket of an adjacent pushable transport cart. In this case, the plug socket can comprise an elastic or elastically supported electric plug contact element, which then forms an electric contact with the plug-in tongue. The plug contact element can be embodied as a spring contact or elastic contact clamp, for example, into which the plug-in tongue can be pushed. Alternatively or cumulatively, it is possible for the plug-in tongue to comprise a snap-in or interlocking surface. The snap-in or interlocking surface of the plug-in tongue interacts with a snap-in or interlocking element of a plug socket of the adjacent pushable transport cart or the stockage and/or charging station for snapping-in or interlocking.

The electric connecting device can comprise any number of connections, connector bars or interfaces depending on the requirements of the electric signals, data, currents or voltages to be transmitted. For a particular proposal, the electric connecting device comprises redundant connections, connector bars or interfaces. The redundant connections, connector bars or interfaces can then each be used for different mounting orientations of the mechanical connecting device. To cite merely one non-limiting example, a connector of a pushable transport cart can be inserted in two orientations rotated by 180° about its longitudinal axis in a plug socket of an adjacent pushable transport cart. In this case, the redundant connections, connector bars or interfaces are arranged on opposite sides in the circumferential direction around the longitudinal axis and at the same distance from the longitudinal axis so that for the two different assembly orientations, one connection, connector bar or interface of the two redundant connections, connector bars or interfaces is arranged in the same position in each case, so that this or these can then interact with a single connection, connector bar or interface of the other pushable transport cart. In this way, use is simplified for the user and incorrect assembly, in which the electric contacting does not meet the requirements, is reliably avoided. Preferably, the mechanical connecting device mechanically specifies the two possible different mounting orientations, for example, which can be ensured by corresponding geometries of the cross-section of plug-in tongue and the associated plug socket.

While the electric connecting device and the two electric components of the pushable transport cart and the neighboring pushable transport cart or the stockage and/or charging station, which are connected to each other, can be embodied as desired in terms of design and geometry, the electric connecting device for a pushable transport cart in one embodiment comprises a plug and/or a plug socket. In this case, the plug or the plug socket may comprise an electric plug contact element. This electric plug contact element can then be elastic or elastically supported in the direction of insertion of a plug into the plug socket. In this embodiment, it is possible for the mechanical connecting device to be mounted via a certain assembly path in the direction of insertion of the plug into the plug socket, the plug being guided in the plug socket via this assembly path. The elastically supported or elastic electric plug contact element can then come into contact with a contact surface of the plug or the plug socket in a final section of the assembly path. With further assembly along the last section, the electric plug contact element is then subjected to an increasing contact force, which results in an increasing elastic deformation of the electric plug contact element itself or the elastic support thereof. In this way, on the one hand, the desired contact force of the plug contact element can be ensured. On the other hand, this elastic contact path of the plug contact element results in a robustness of the electric contacting independent of any fluctuations in the assembly path and/or manufacturing tolerances.

It is possible that the plug and the plug socket form an insertion aid, via which, for example, a type of centering can take place via the assembly path. It can be advantageous if this insertion aid ensures that the longitudinal axes of the plug and the plug socket are already aligned before the start of the contacting path or before the last partial path, so that when the plug contact element of the plug or the plug socket comes into contact with the plug socket or the plug, the plug contact element already comes into contact with the intended contact surface. This enables precise contacting, whereby the user is supported by the insertion aid.

For one pushable transport cart, the mechanical connecting device comprises a magnet, which is in particular a permanent magnet. Preferably, the plug of one pushable transport cart and the plug socket of the neighboring pushable transport cart each comprise a permanent magnet, with the poles of these permanent magnets being oriented in such a way that the two permanent magnets attract each other when the mechanical connection is established. The permanent magnets of the mechanical connecting device can be used to secure the mechanical connection with magnetic force. This magnetic force can also ensure that the electric connection created via the electric connecting device is secured against unintentional disconnection. However, it is also possible that only one permanent magnet is arranged either in the plug [or in the plug socket], which then generates a magnetic force with a metallic body in the plug socket [or in the plug]. An electromagnet can also be used instead of the at least one permanent magnet. In addition to ensuring contact between the plug and the plug socket, the at least one magnet can also provide a mechanical securing force. If an electromagnet is used, the release of the mechanical locking mechanism can be made dependent on the authentication of a user.

For one embodiment, a further electric connecting device, which is provided by the contact elements, is located on the pushable transport cart at a distance from the electric connecting device integrated in the mechanical connecting device.

It is in principle possible for the two electric connecting devices to be used for different purposes, in particular for transmitting different signals, for transmitting data on the one hand and electric power on the other hand, and the like. For a particular proposal, the electric connecting device and the further electric connecting device form at least one closed circuit such that the electric circuit comprises a feed line from the supply and/or charging station or the neighboring pushable transport cart to the pushable transport cart, which is provided by the electric connecting device, and a return line, which is provided by the further electric connecting device with the contact elements and leads back from the pushable transport cart to the stockage and/or charging station or to the neighboring pushable transport cart. In this case, the electric circuit is only closed when both electric connecting devices establish a connection. Electric power (or data or signals) can then be transmitted via the closed electric circuit, for example. If, in contrast to this embodiment, a closed circuit is provided solely by the electric connecting device integrated into the mechanical connecting device, so that connections for the supply line and the return line are present on the same component, contact by the user with both connections could lead to a short circuit via the user, which could be uncomfortable for the user or even lead to damage to health. Such a short circuit is made more difficult or avoided for the embodiment explained here: If, for example, the further electric connecting device is located in the area of the chassis of the pushable transport cart, the user would have to contact both electric connecting devices simultaneously for such a short circuit and bridge the distance between these two electric connecting devices, which is unlikely or impossible depending on the position of the connecting devices.

The electric connecting device and/or the contact elements can contain or form any number of connections, which can be embodied as individual connections, can be integrated into a connection or connector bar or can be provided in an interface of any design. It is possible, for example, that the electric connecting device and/or the contact elements may comprise connections for an electric power supply. In this case, the electric connecting device and/or the contact elements can be used to transmit a direct current or alternating current or any other electric signals.

Alternatively or cumulatively, it is possible that the electric connecting device comprises at least one connection for a charging station detection or that the contact of the contact elements serves a charging station detection. This charging station detection can, for example, comprise a line looped through a row of interconnected pushable transport carts, via which an electric signal can be received by a control unit of the pushable transport cart, which provides information as to whether the row of pushable transport carts is connected to a charging station and thus whether a charging voltage is applied to the line of pushable transport carts or not. Alternatively or cumulatively, the electric connecting device can comprise an (auxiliary) connection or the contact elements can serve as an (auxiliary) connection via which any additional signals can be transmitted or measurement signals from sensors of neighboring pushable transport carts can be transmitted. Alternatively or cumulatively, the electric connecting device can comprise at least one connection for signal transmission and/or data transmission or the contact elements can be used for this purpose.

It is quite possible that in the pushable transport cart the storage device is permanently connected to the electric connecting device or the contact elements, leading to the result that whenever a supply voltage is applied to the electric connecting device or the contact elements, the storage device is supplied with the supply voltage and, depending on the state of the storage device, the storage device is charged or discharged. In one embodiment of the pushable transport cart, it comprises a storage release device. The storage release device is interposed between the electric connecting device or the contact elements and the storage device and is embodied such that, in a release position thereof, the storage release device connects the storage device to the electric connecting device or the contact elements in order to enable the charging state of the storage device to be changed via the electric connecting device. On the other hand, the storage release device also has a disconnected position. In the disconnected position, the storage release device disconnects the storage device electrically from the electric connecting device or the contact elements. In the simplest case, the storage release device is embodied as a type of electronic switch comprising the release position and the disconnected position. The release position can be used to change the charge state of the storage device, which can consist of the storage device being charged via a charge voltage applied to the electric connecting device or the contact elements. It is also possible for the storage device to be discharged in the release position so that the storage device can deliver electric power to an adjacent pushable transport cart via the electric connecting device or the contact elements.

If the storage release device is in the disconnected position, the voltage applied to the electric connecting device or the contact elements cannot be used. It is also possible that the voltage present here is not used to change the charge state of the storage device, but is passed on from the pushable transport cart to a neighboring pushable transport cart.

It is possible that a charge flow control unit is present. This charge flow control unit is then connected between the plug and the plug socket (if charging takes place via this) and/or the contact elements (if charging takes place via these). Furthermore, the charge flow control unit connects the plug or the plug socket or the contact element to the storage device, which may be done via the storage release device. The charge flow control unit can then comprise two different operating modes, namely a pass-through operating mode and a charging operating mode:

In the feed-through operating mode, the charge flow control unit connects the plug to the plug socket or the contact elements to each other, so that electric energy can be fed through the pushable transport cart for transmission to an adjacent pushable transport cart. In the pass-through operating mode, the charge flow control unit simultaneously disconnects the connection of the storage device with the plug or the plug socket or the connection of the storage device with at least one contact element, so that the charge state of the storage device is not affected.

On the other hand, in the charge operating mode the charge flow control unit disconnects the plug from the plug socket or the contact elements from each other, so that the electric energy is not passed through or transferred. Rather, in the charging operating mode, the charge flow control unit ensures a connection between the storage device and the plug or the plug socket or at least one contact element, which makes it possible to charge the storage device (or discharge the storage device) via the plug or the plug socket or the contact element(s).

Under certain circumstances, it may be desirable for a line of pushable carts connected to a charging station to only pass electric energy from the charging station in one direction to the pushable transport cart located furthest away from the charging station, while not allowing current to flow in the opposite direction. In this case, a direction-determining current flow element, in particular a diode, can be connected between the plug and the plug socket or between the contact elements. If, on the other hand, the direction of the possible current flow is to be controllable, a bypass to the diode or to the direction-determining element can also be provided, the release of which also permits a reversal of the current flow.

In one embodiment the pushable transport cart has a current sensor or—switch. The current sensor or switch can be used to control or regulate the flow of electric signals. To give just one non-limiting example, a current sensor or switch can be arranged upstream of the plug on the output side of the charging station or the plug socket on the output side or the contact element on the output side. If the pushable transport cart in the line of pushable transport carts connected to the charging station is the furthest one from the charging station, no current flows via this output-side plug or the plug socket or the contact element, as no other pushable transport cart is connected here. The current sensor or switch can therefore detect that no current is being passed through and thus cause the output-side plug or the plug socket or the output-side contact element to be blocked. This can be done, for example, by switching the aforementioned charge flow control unit of this outermost pushable transport cart to the charging operating mode or by switching the charge flow control unit to a disconnected operating mode by not connecting the input-side plug or the input-side plug socket or the input-side contact element to either the storage device or the outlet-side plug socket or the outlet-side plug or the outlet-side contact element.

It is possible that the charging station provides electric power by supplying a DC voltage or an AC voltage, which can then be used to charge the storage device. For one proposal, it is also possible for the charging station to provide AC voltage. In this case, the pushable transport carts then have an AC/DC voltage converter that converts the AC voltage provided by the charging station into a DC voltage, which can then be used to charge the storage device. If an AC voltage is used, this results in independence from the polarity.

For a further proposal, the pushable transport cart comprises a charging device by means of which a portable electronic device of the customer, in particular a smartphone, can be charged. Charging is carried out from the storage device of the pushable transport cart, wherein alternatively or cumulatively or temporarily charging can also be carried out with energy from the charging station. The charging device can be connected wired or wirelessly to the customer's portable, mains-powered electronic device, for which purpose an inductive charging cradle can be used, for example.

It is possible that a voltage level provided by the charging station corresponds to the voltage level of the “on-board power supply” of the pushable transport cart. However, for a particular embodiment, the pushable transport cart comprises a voltage converter that changes the voltage level. Such a voltage converter may, for example, be a so-called buck-boost converter or inverse converter. To give just one non-limiting example, the charging station can provide electric power with a low voltage level, for example with a voltage level of maximum 24 V, maximum 12 V or maximum 5 V, whereby deviations from these maxima of ±2 V or ±1 V are also possible. The voltage level is selected in such a way that the user is not affected if a short circuit occurs via the user with this voltage level. This voltage level is then used exclusively for communication between the charging station and/or the pushable transport carts. The voltage level is then raised by means of the voltage converter to a voltage level which is, for example, more than 20%, more than 50% or more than 100% greater than the previously specified voltage level and could lead to impairment of the user in the event of a short circuit of this voltage level via the user. The higher voltage level can then be used to operate the electronic devices and to charge and operate the storage device.

For a further proposal, a wireless transmitting and/or receiving device (in particular a Bluetooth device, a LoRa device, a BLE device and/or a WiFi device) is provided in the pushable transport cart. By means of the wireless transmitting and/or receiving device, the pushable transport cart can communicate, for example, with the stockage and/or charging station, a server and a computing unit of the supermarket, a checkout device of the supermarket and/or a portable, network-compatible electronic device of the customer in order to exchange any data in one of the directions or bidirectionally. If, for example, items placed in a shopping cart are detected, the wireless transmitting and/or receiving device can be used to transmit the items to the checkout system, which can then trigger an automated payment process. However, it is also possible for products placed in the shopping cart to be visually detected using the customer's smartphone, for example by detecting the barcode, and then the detected article can be transmitted to the pushable transport cart for further processing via the wireless transmitting and/or receiving device.

The electric connecting device (and possibly also the mechanical connecting device in which the electric connecting device is integrated) may comprise a flexible connecting cord which is connected in one end region to the plug or the plug socket, while the other end region of the flexible connecting cord may be connected, for example, to the handling device of the pushable transport cart, in particular a pushrod of the shopping cart or the baggage cart. In this case, it is possible that the connecting cord comprises a core, a jacket and/or a wire rope in order to absorb mechanical forces acting on the connecting cord and to keep them away from electric connections and connecting cords.

The connecting cord is used for the electric connection and, if necessary, mechanical connection of two or more pushable transport carts. With its longitudinal extension, the connecting cord bridges a defined connecting distance between successive pushable transport carts. The connecting cord can be a flexible or rigid cord. At least one section of the connecting cord can also be flexible and at least one other section of the connecting cord can be rigid.

For a particular embodiment, an optical detection device is also integrated into the mechanical connecting device in addition to or with the electric connecting device. If the optical detection device is a barcode scanner or QR scanner, the mechanical connecting device is further optimized with regard to multifunctional use, in that it not only serves to integrate the electric connecting device and the mechanical connection, but also comprises the scanner, which can then for be used to scan articles placed in a shopping cart for recognizing the articles.

It is possible that the pushable transport cart comprises an identifier specific to this pushable transport cart, which can be transmitted via the electric connecting device or the contact elements. This specific identifier can be used for a variety of purposes. For example, the specific identifier can be used to localize the individual pushable transport carts by means of a position detection system (in particular GPS) of the transport cart. Furthermore, the number of pushable transport carts connected in a line can be determined by recognizing the specific identifiers. It is possible that (for example in a control unit and storage unit of the pushable transport cart, the stockage and/or loading station, a server of the supermarket and/or a checkout system of the supermarket) specific information for the pushable transport carts is collected, for example an operating time of the same, load characteristics of the same and information such as date and type of repair and maintenance with possibly a monitoring of repair or maintenance intervals). The data or signals determined in this way can then be transmitted via the electric connecting device and/or the contact elements.

A pushable transport cart system has at least two pushable transport carts that are pushed into each other. In the pushed-in state, an electric contact between the contact elements of the pushable transport carts is established as a result of the push-in movement, wherein it is also possible for an (additional) electric connecting device to ensure an electric contact manually via the mechanical connecting device of the plug with the plug socket.

It is possible that the pushable transport cart system also comprises a stockage and/or loading station, which is connected to the pushable transport carts connected to each other in a line for storing and/or loading the pushable transport carts. In this case, there is an electric connection between the pushable transport carts and the stockage and/or loading station via the electric connecting device and/or the contact elements of the pushable transport carts.

Possible designs of control logic for operating the pushable transport cart or pushable transport cart system are mentioned and explained below. Here, the control logic is executed on a control unit of the pushable transport cart (in particular a charge flow control unit and/or a storage release device) and/or on a central control unit (for example a control unit of the stockage and/or charging station). In this case, the signals, data, currents, voltages, identifiers and/or control commands can be transmitted via the electric connecting device and/or the contact elements between two nested pushable transport carts and/or the charging and/or stockage station:

For one proposal, control logic is present in the pushable transport cart system or the pushable transport carts, which recognizes when the or a pushable transport cart is mechanically and/or electrically connected (or not connected) to an adjacent pushable transport cart. If such a connection is detected, the pushable transport cart can be locked, for example (in particular by locking a mechanical connecting device, by energizing an electromagnet that electromagnetically couples the pushable transport carts, by locking the wheels of the pushable transport cart, etc.). The locking mechanism can then be released later, for example by inserting a coin into a coin-operated lock on the associated pushable transport cart. It is also possible for the locking of the cart to be released via an app on the user's smartphone that communicates with the pushable transport cart. If, after the user has borrowed a pushable transport cart, the pushable cart is properly parked again, which is recognized by the detection process described above, an amount can be refunded to the user in accordance with a physical coin system, in particular via a customer app of the operator of the supermarket. It is also possible that if the app detects that the cart has been properly parked, an incentive is offered to the customer for his or her next purchase, which can create additional customer loyalty. The user's motivation to properly park the pushable transport cart can also be increased by displaying information about the user and the shopping behavior, for example a name and/or the list of purchases made, on a screen of the pushable transport cart until the cart is properly parked. Assuming that the user wants to prevent this information from reaching third parties, the user is therefore motivated to park the cart properly.

Alternatively or cumulatively, it is possible that control logic is present in the pushable transport cart or the pushable transport cart system, which detects the number of pushable transport carts connected in a line to each other and/or to a stockage and/or charging station. This detection can be carried out, for example, by each pushable transport cart comprising a specific identifier exchanged between the line of pushable transport carts and/or the stockage and/or charging station, the detection of which can then be used to determine the number of pushable transport carts. However, it is also possible that a transfer resistance between the pushable transport carts, which is dependent on the number of pushable transport carts connected in series, is detected and the number of interconnected pushable transport carts is then determined on the basis of the transfer resistance. Based on the determined number of interconnected pushable transport carts, the loading management can then be controlled, for example, a message or an alarm can be sent to a user or a person or company that runs the supermarket that there is void or congestion of pushable transport carts at a stockage station for the pushable transport carts, or the customer flow can be directed to another stockage station where there is no risk of void.

Alternatively or cumulatively, there may be control logic that ensures charge flow management. The charge flow management has a pass-through operating mode and a charging operating mode:

In the pass-through operating mode, the plug is connected to the plug socket (in particular via the aforementioned charge flow control unit) or the contact elements are connected to each other, while the connection of the storage device to the plug or the plug socket or to the contact elements is disconnected.

In the charging mode, however, the plug is disconnected from the plug socket or the contact elements are disconnected from each other while the storage device is connected to the plug or the plug socket or the storage device is connected to a contact element.

If the charge flow management recognizes that there is a greater load requirement on one pushable transport cart than on another pushable transport cart, the charge flow management switches the charge flow control unit of the first-mentioned pushable transport cart to the charge operating mode, while the at least one second-mentioned pushable transport cart is switched to the pass-through operating mode.

The criterion for determining which pushable transport cart comprises a higher charging need can, for example, depend on the respective charging levels, in that a lower charging level correlates with a higher charging requirement. Alternatively or cumulatively, the location of the pushable transport cart in the line of pushable transport carts can be taken into account—the greater the distance from the charging station, the greater the need for charging.

Alternatively or cumulatively, control logic can be provided that ensures charge flow management, in which a specific load quantity for a supermarket or a baggage transport area is taken into account. This specific load quantity correlates with the expected energy requirement for an average use of the pushable transport cart in the area of the supermarket or the baggage transport area, wherein a certain safety margin can be added. If the supermarket is a small supermarket, the specific load quantity is smaller than for a large supermarket or even a supermarket with different stores, since in the latter case a user travels longer with the pushable transport cart for a normal shopping operation. In one embodiment, the same pushable transport cart can be sold for different supermarkets or baggage transportation areas, wherein the different specific charge quantities can still be taken into account. The specific charge quantity is taken into account for the charge flow management in such a way that, in the case of a higher specific charge quantity, the switchover from charging in particular a pushable transport cart located further away from the charging station to a pushable transport cart located closer to the charging station takes place when the charge level corresponds to the specific charge quantity.

Alternatively or cumulatively, control logic can be provided for charge flow management, in which specific demand parameters are taken into account for a supermarket or a baggage transport area and/or for a time and/or a day of the week, which correlate with an increased demand for the use of pushable transport carts per time unit by the users. If the frequency of use of a supermarket or a baggage transport area and the associated stockage station, a peak time or a weekday with an increased number of users results in pushable transport carts being removed from the stockage station at a higher frequency, this results in an increased specific demand parameter. For a larger specific demand parameter, care must then be taken to ensure that more pushable transport carts with a minimum charge level are provided at the stockage station during these “peak times”. This can result in several pushable transport carts being loaded simultaneously by means of the charge flow management, which are arranged on the side of the line of pushable transport carts facing the user; or, starting from the outermost pushable transport cart, the pushable transport carts are successively loaded to a reduced voltage level as a result of the increased specific demand parameter. If, on the other hand, the specific demand parameter indicates that a pushable transport cart is only very rarely removed from the stockage station, the pushable transport cart furthest from the charging station can be charged to a higher voltage level.

For the specific demand parameter, a priori defined empirical values or empirical values determined over time during operation of the pushable transport cart system can be used. It is also possible for the specific demand parameter to be determined using self-learning or artificial intelligence and/or for the specific demand parameter to be taken into account in the charge flow management system using self-learning or artificial intelligence.

Alternatively or cumulatively, it is possible that control logic is present in the pushable transport cart system, which provides a charge flow management such that, in the case of a line of pushable transport carts connected to the stockage and/or charging station, the pushable transport cart furthest away from the stockage and/or charging station is charged first until a threshold value of the charging state is reached. Then, the pushable transport carts adjacent in the direction of the stockage and/or charging station are successively charged. If during the charging (in particular of a pushable transport cart that is not furthest away from the charging station) a user connects a pushable transport cart to the end of the line facing away from the charging station during charging, a switchover can take place in such a way that this pushable transport cart, which is now furthest away from the charging station, is charged first.

The previously explained mechanisms can be used to determine the threshold value of the state of charge without this necessarily being the case.

Alternatively or cumulatively, a control logic can be present in the pushable transport cart system that ensures charge flow management in such a way that a storage device of a pushable transport cart is charged from a storage device of at least one other pushable transport cart. It is also possible here that in selected operating states, in particular with an increased demand for charging a pushable transport cart (in particular on the basis of a detected large specific demand parameter) charging of a storage device of a pushable transport cart takes place simultaneously from a storage device of at least one other pushable transport cart and from the charging station. This operation can also be described as a type of boost charging operation.

It was previously described how the charge management between the pushable transport carts can be dependent on the distance of the pushable transport carts from a charging and/or stockage station. The same can also apply to a line of pushable transport carts that are not connected to a charging station. In this case, the pushable transport cart adjacent to the charging station in the previous description corresponds to the first pushable transport cart in the line, into which the other pushable transport carts in the line are successively inserted from behind, while the pushable transport cart furthest from the charging station in the previous description corresponds to the last pushable transport cart in the line, which is therefore the first pushable transport cart that can be removed from the line by the users.

For a further proposal, the pushable transport carts and/or the stockage and/or charging station in the pushable transport cart system have control logic which detects when a pushable transport cart is separated from another pushable transport cart and/or from a stockage and/or charging station. This can be done, for example, by means of a switch between the pushable transport carts, by means of a distance sensor, by means of the dip in a signal transmitted between the pushable transport carts with the separation, by means of a change in the resistance of an electric line or a contact between the pushable transport carts or by means of the geodetic locations of the pushable transport carts. Alternatively or cumulatively, a separation of the contact elements of the pushable transport carts, a separation of the mechanical connecting devices and/or the electric connecting devices can be detected in a corresponding or different way.

There are many different ways of using a detected separation. For one proposal, the pushable transport carts in the pushable transport cart system have control logic which activates a display of a pushable transport cart when a separation is detected, thus preparing the pushable transport cart for use by the user. Alternatively or cumulatively, a wireless transmitting and/or receiving device can be activated. It is also possible that a tracking function is activated, by means of which the location of the removed pushable transport cart is tracked. On the one hand, this can be used to track the flow of customers in a supermarket or for the flow of baggage carts. However, it is also possible to use this to monitor theft, whereby a theft warning is generated, for example, when the tracked location of the pushable transport cart leaves a defined territory. Alternatively or cumulatively, it is possible that a product scanner is activated when a separation is detected, by means of which the user can scan shopping products on a pushable transport cart embodied as a shopping cart before they are placed in the shopping cart. Alternatively or cumulatively, it is possible that when a separation is detected, shopping processing software is activated which, for example, records the shopping items selected by the customer, provides the customer with information for his or her purchase, enables the shopping cart to communicate with the customer's mobile phone and/or enables a (semi-automatic or fully automatic) payment process.

For a further proposal, the pushable transport carts in the pushable transport cart system have control logic which performs a self-test of the pushable transport cart when a separation is detected. Alternatively or cumulatively, an electric signal or a sensor signal of the pushable transport cart can be checked during the self-test in order to determine whether the pushable transport cart is functional or meets the specifications.

If the self-test leads to the result that an improper state is present, for example the charge level of the storage device is not sufficient or an electric signal or sensor signal is not in order, the control logic of the pushable transport cart sends information to the user, which can be indicated by an information on a display of the pushable transport cart or an acoustic signal. It is also possible for such information to be given to the user via the user's smartphone. In particular, an information is generated on a display of the pushable transport cart or the smartphone, which informs the user that the self-test was negative, shows the user the result of the self-test or prompts the user to use another pushable transport cart and/or to reconnect the pushable transport cart to a stockage and/or charging station or to send it to a rejection area. Information can also be automatically generated and transmitted to an operator that the pushable transport cart is not in order.

It is also possible that the pushable transport carts of the pushable cart system have control logic which detects the establishment of a connection between two pushable transport carts, between contact elements, mechanical connecting devices and/or electric connecting devices.

If the establishment of a connection of that type is detected, a display of a pushable transport cart can be deactivated and/or a wireless transmission and/or reception device can be deactivated. Alternatively or cumulatively, a tracking function for tracking the location of the pushable transport cart can be deactivated, a product scanner can be deactivated and/or the previously explained purchase processing software can be deactivated.

For a particular proposal, the pushable transport carts have control logic that detects, on the basis of a signal from a sensor, whether a shopping product or an object belonging to the user is still on the pushable transport cart when the connection is established. If this is the case, the user is informed that there is still a product or an object belonging to the user on the pushable transport cart. In this way, it is possible to prevent the user for example from accidentally forgetting a purchased product on the pushable transport cart, when the pushable transport cart is parked at the end of the shopping process. Detection can be based on a signal from a load cell, which records the weight of the product forgotten on the pushable transport cart. Alternatively or cumulatively, detection can be based on a sensor in the form of a camera, which captures the forgotten item as an image using automatic image recognition software to analyze the image captured by the camera.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows a top view of connecting devices of two pushable transport carts.

FIG. 2 shows a section II-II through the connecting devices of two pushable transport carts as shown in FIG. 1.

FIG. 3 shows a section III-III through the connecting devices of two pushable transport carts as shown in FIGS. 1 and 2.

FIG. 4 shows a spatial view of a connector of the connecting devices of two pushable transport carts according to FIGS. 1 to 3.

FIG. 5 shows an alternative configuration of connecting devices for two pushable transport carts in a plan view.

FIG. 6 shows a section VI-VI through the connecting devices of two pushable transport carts as shown in FIG. 5.

FIG. 7 shows spring-loaded plug contact elements of a plug of the connecting devices of two pushable transport carts as shown in FIGS. 5 and 6.

FIG. 8 shows a connector of the connecting devices of two pushable transport carts according to FIG. 5 to 7 in a spatial view.

FIG. 9 shows a spatial view of a plug socket for the connecting devices of two pushable transport carts as shown in FIGS. 5 to 8.

FIG. 10 shows a section through a further embodiment of connecting devices for two pushable transport carts.

FIG. 11 shows a detail of a plug socket for the connecting devices of two pushable transport carts as shown in FIG. 10.

FIG. 12 shows a plug of the connecting devices of two pushable transport carts according to FIGS. 10 and 11.

FIG. 13 to 18 show electric schematic circuit diagrams of embodiments of a pushable transport cart system with a charging station and three pushable transport carts connected in a line.

FIG. 19 shows a three-dimensional view of a pushable transport cart in the form of a shopping cart with contact elements in the area of a chassis frame.

FIG. 20 shows a detailed view of a first contact element of the pushable transport cart according to FIG. 19.

FIG. 21 shows a second contact element of the pushable transport cart as shown in FIG. 19.

FIG. 22 shows a detailed plan view of several pushable transport carts pushed into one another in the longitudinal direction to form a pushable transport cart system as shown in FIG. 19 in the area of the chassis frame and contact elements.

FIG. 23 shows a three-dimensional view of a further embodiment of a pushable transport cart in the form of a shopping cart with contact elements.

FIG. 24 shows a detailed spatial view from below of the first and second contact elements of the pushable transport cart shown in FIG. 23.

FIG. 25 shows from below a pushable transport cart system with two incompletely inserted pushable transport carts as shown in FIG. 23 in the area of the chassis frames and contact elements.

FIG. 26 shows from below a pushable transport cart system with three pushable transport carts fully inserted into one another as shown in FIG. 23 in the area of the chassis frames and contact elements.

FIG. 27 shows a longitudinal section XXVII-XXVII through the pushable transport cart system as shown in FIG. 26.

FIG. 28 shows a detail XXVIII from FIG. 27.

FIG. 29 shows a three-dimensional view of a further embodiment of a pushable transport cart in the form of a baggage cart with contact elements and a fixing brake.

FIG. 30 shows a rear view of the pushable transport cart as shown in FIG. 29.

FIG. 31 shows a detail XXXI of the spatial view according to FIG. 29.

FIG. 32 shows a detail XXXII of the view of the pushable transport cart from the rear as shown in FIG. 30.

### DETAILED DESCRIPTION

In the figures, components and features that correspond or are similar are sometimes identified with the same reference signs, whereby these components or features can then be distinguished from one another by the addition “−1”, “−2”, . . . . Reference can then also be made to these structural elements and features without the addition, which can then mean one such structural element or feature, any number of such structural elements or features or all structural elements or features identified in this way.

In the figures, different pushable transport carts and their components are distinguished from one another by the letters a, b, c. Reference can then also be made to these pushable transport carts and their components without the letter, which can then mean a pushable transport cart or a component, any number of such pushable transport carts and components or all pushable transport carts and components marked in this way.

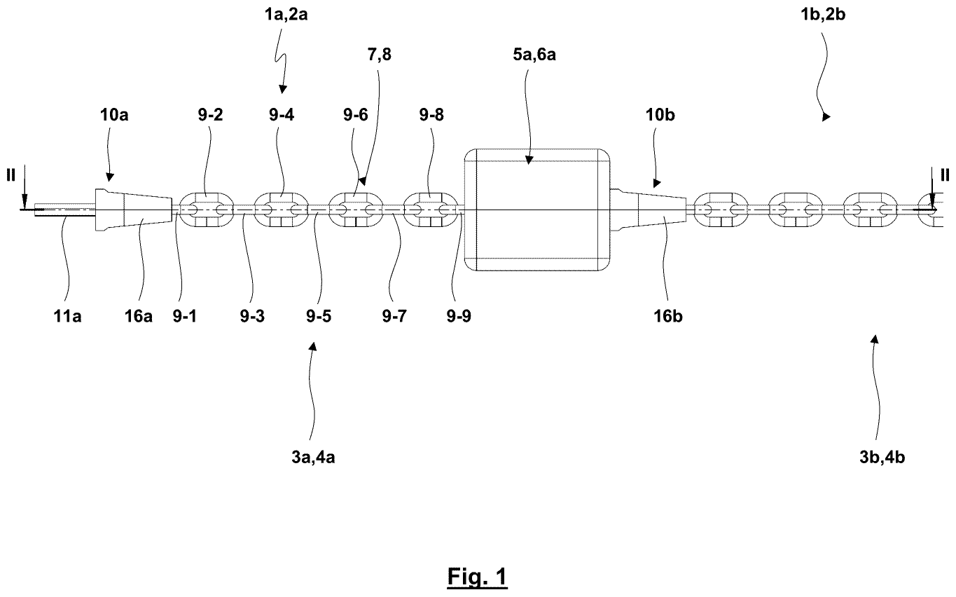

FIG. 1 shows a mechanical connecting device 1 and an electric connecting device 2 of two pushable transport carts 3a, 3b, which are in particular shopping carts 4a, 4b. The connecting devices 1, 2 have a common housing 5. A coin-operated lock 6 of the mechanical connecting device 1 is arranged in the housing 5. The housing 5 is connected to a plug 10 via a flexible connecting cord 7 (here a securing chain 8 with (chain) members 9a, 9b, . . . ).

The plug 10 has a plug-in tongue 11. The plug-in tongue 11 comprises a snap-in or interlocking surface 12. For the embodiment shown, the snap-in or interlocking surface 12 is embodied as a through-recess 13 of the plug-in tongue 11. In the snap-in or interlocking position of the coin-operated lock 6, a snap-in or interlocking element 14 engages or locks with the snap-in or interlocking surface 12. In the illustrated embodiment example, this is achieved by the snap-in or interlocking element 14 entering the through-recess 13 in a form-fitting manner. The snap-in or interlocking element 14 is arranged in a plug socket 15 of the housing 5 and coin-operated lock 6, into which the plug 10 can be inserted. If there is a coin in the coin-operated lock 6, the snap-in or interlocking element 14 releases the plug-in tongue 11, allowing the plug 10 to be removed from the plug socket 15. If, on the other hand, there is no coin in the coin-operated lock 6, the plug 10 is secured in the plug socket 15 by the interaction between the snap-in or interlocking element 14 and the snap-in or interlocking surface 12. Preferably, the snap-in or interlocking element moves between the snapped-in or interlocked position and the non-snapped or non-interlocked position transversely to the insertion direction of the plug 10 into the plug socket 15. If the plug 10 is arranged in the plug socket 15 and the coin-operated lock 6 is in the latched or locked position, the mechanical connecting device forms a safeguard for the two pushable transport carts 3a, 3b, which are pushed into one another, against them being pulled apart and thus against a pushable transport cart 3b being removed and used.

The electric connecting device 2 is integrated into the mechanical connecting device 1. For this purpose, the plug-in tongue 11 is embodied as electrically conductive. The end section of the plug-in tongue 11 arranged in a plug housing 16 is contacted by one end section of a connecting cable 17. The other end section of the connecting cable 17 establishes contact with the link 9-1 of the securing chain 8, which is firmly connected to the connector housing 16. As a result of gravity, the interlocking members 9-1, 9-2, . . . are in contact with each other. As a result of this contact and the electrically conductive design of the members 9, the securing chain 8 forms an electric conductor. The member 9-9 furthest away from the plug 10 is permanently connected to the housing 5. This member 9-9 is electrically contacted by a connecting cable 18 extending through the housing 5.

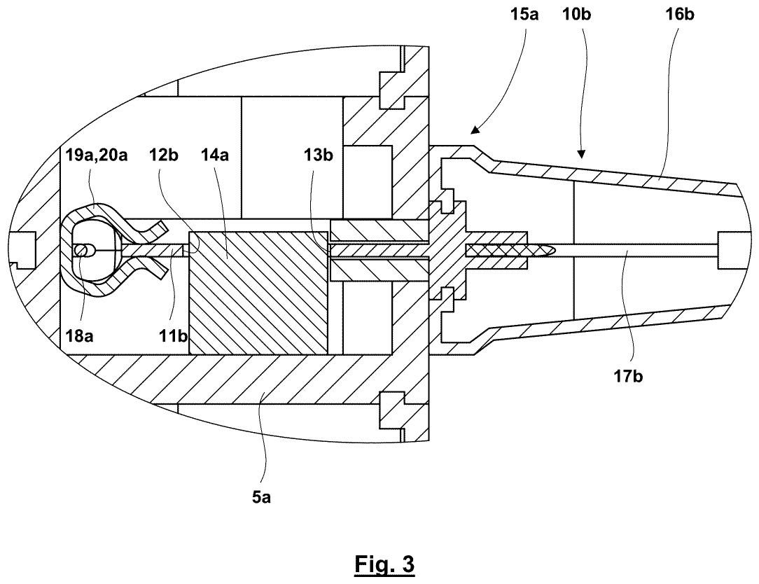

An electric plug contact element is located in the plug socket 15, which is embodied as an elastic contact clamp 20 for the embodiment shown. The contact clamp 20 has a roughly U-shaped cross-section. The base leg of the U is attached to the housing 5, while the plug-in tongue 11 can be inserted between the side legs of the U with elastic expansion of the side legs. The contact force between the contact clamp 20 and the plug-in tongue 11 is brought about by the elastic restoring force of the contact clamp 20. The connecting cable 18 is connected to the base leg of the contact clamp 20 (see FIG. 3.).

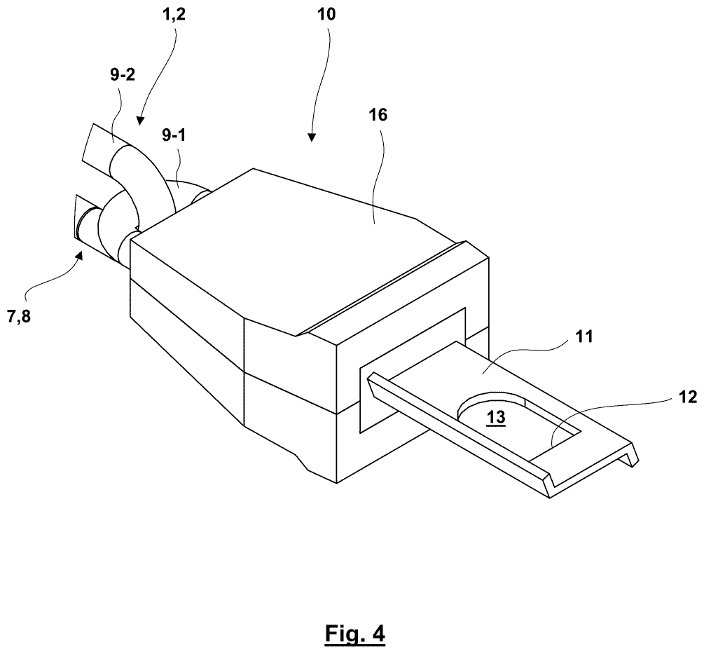

FIG. 4 shows a three-dimensional view of the plug 10 with the plug-in tongue 11. It can be seen here that the plug-in tongue 11 comprises angled edges oriented in opposite directions. The plug socket 15 has a correspondingly shaped receiving contour, so that form-fit insertion of the plug 10 with the plug-in tongue 11 into the receiving contour of the plug socket 15 is possible in two orientations rotated by 180° around the longitudinal axis of the plug 10.

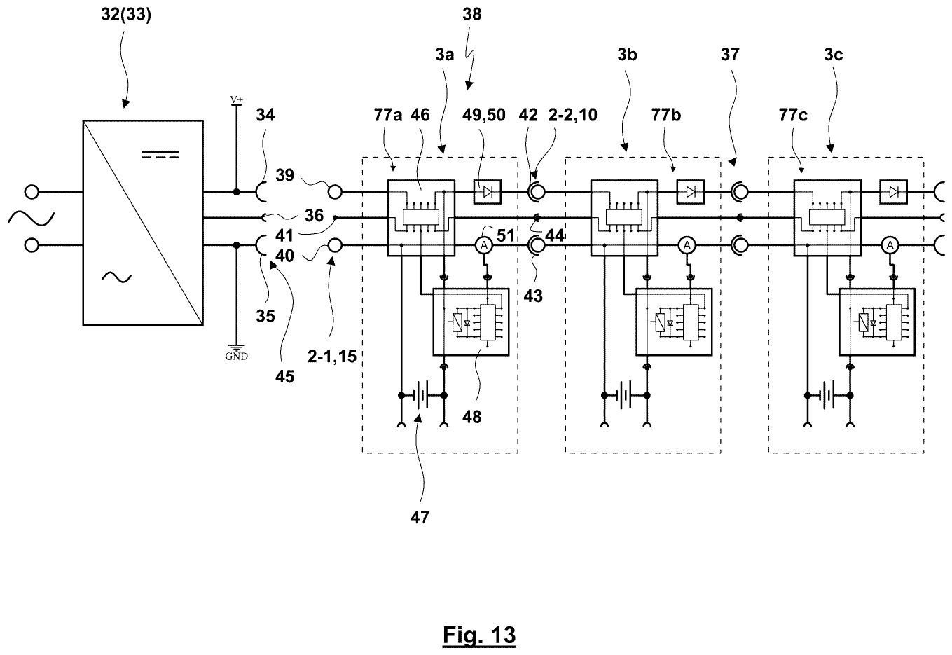

The connecting cable 18 is connected to other electronic components of the pushable transport cart 3a in a manner not shown, as will be explained in more detail below with reference to FIGS. 13 to 18.

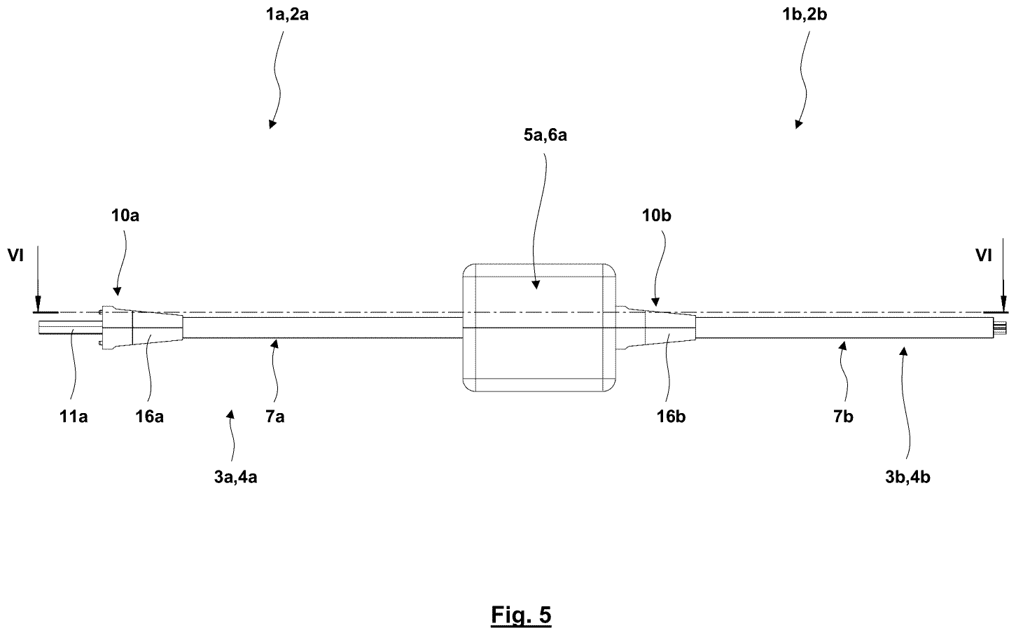

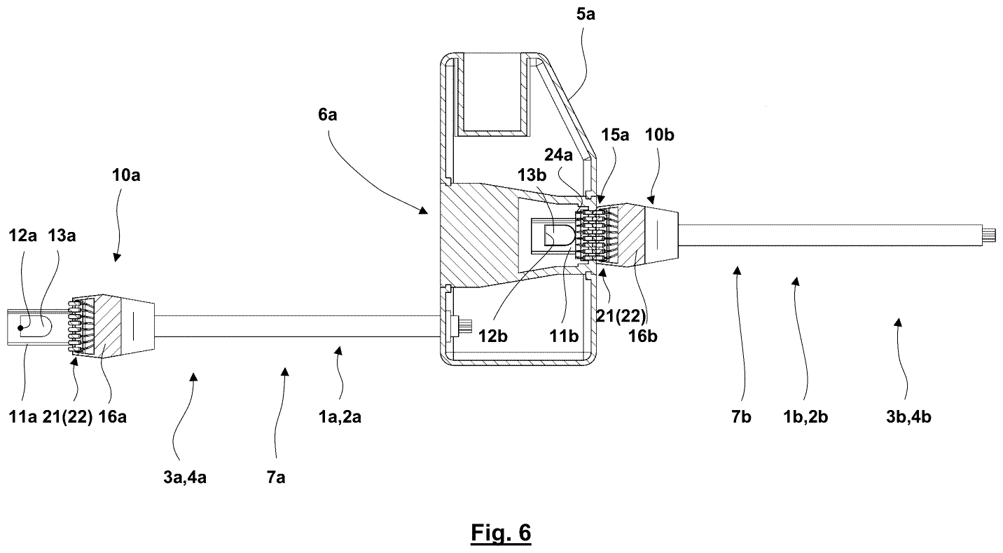

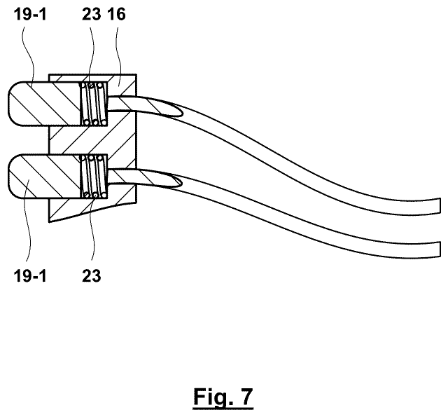

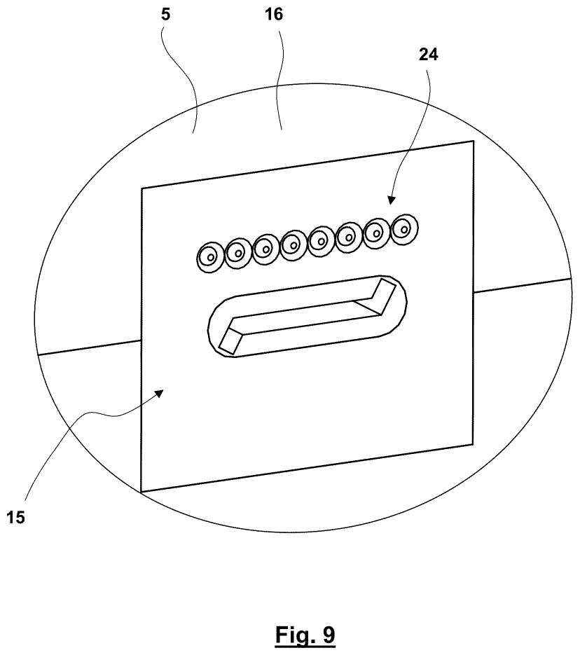

FIGS. 5 to 9 show another embodiment in which the plug 10 comprises two connector bars 21, 22 arranged on opposite sides of the plug-inn tongue 11 on the end face of the plug housing 16, each of which comprises several plug contact elements 19. As can be seen in particular in the partial section in FIG. 7, the plug contact elements 19 are themselves embodied as rigid here, but are supported in the plug housing 16 via springs 23. In each case, a pair of plug contact elements 19 arranged at the corresponding position in the connector bars 21, 22 are connected to a common electric conductor in order to ensure that the plug 10 can also be inserted into the plug socket 15 in two orientations rotated by 180° about the longitudinal axis with the desired electric contact for this embodiment. The plug socket 15 comprises only one connector bar 24, which then interacts with the connector bar 21 in a first orientation of the plug 10, while the same connector bar 24 of the plug socket 15 interacts with the other connector bar 22 in the second orientation.

For the embodiment shown, the connecting cord 7 is not embodied as a securing chain 8, but as a multi-core cable of the electric connecting device 2, whereby the multi-core cable can be provided with reinforcement and/or insulation or sheathed to form the mechanical connecting device 1. In this case, the plug-in tongue 11 is not part of the electric connecting device.

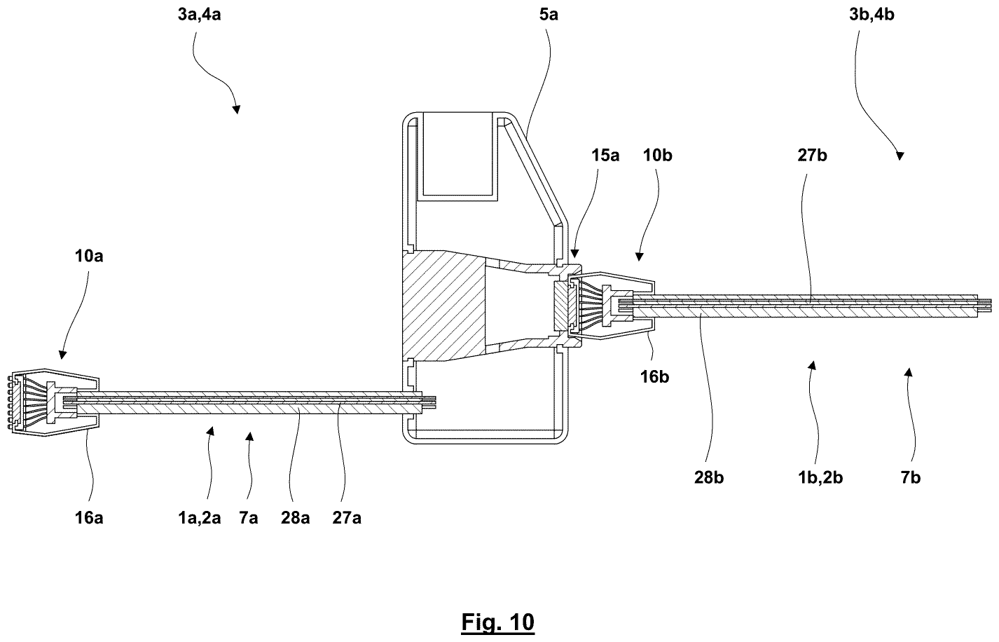

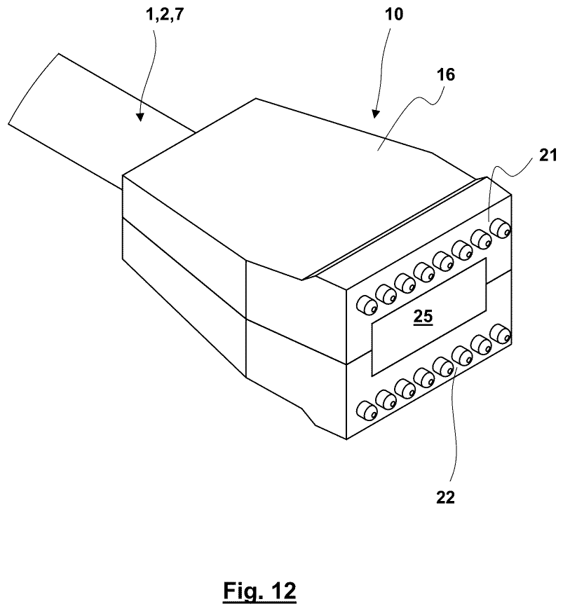

For the embodiment according to FIGS. 10 to 12, the plug socket 15 and the plug 10 each have a permanent magnet 25, 26, which, when the plug 10 is inserted into the plug socket 15, lie against each other and secure the mechanical and electric connection created. However, it is also possible that only one permanent magnet 26 [or 25] is provided on the plug socket 15 [or on the plug 10], which then generates a magnetic securing connection force with a metallic counterpart of the plug 10 [or the plug socket].

FIGS. 10 to 12 also show a possible structure of the connecting cord 7. In this case, a multi-core cable 27 or several cables extend through a jacket 28, which is preferably a Kevlar jacket.

In the embodiment shown in FIGS. 10 to 12, the plug 10 does not have a plug-in tongue 11. Instead, the permanent magnet 25 and the connector bars 21, 22 are arranged in the area of the (here flat) end face of the plug 10.

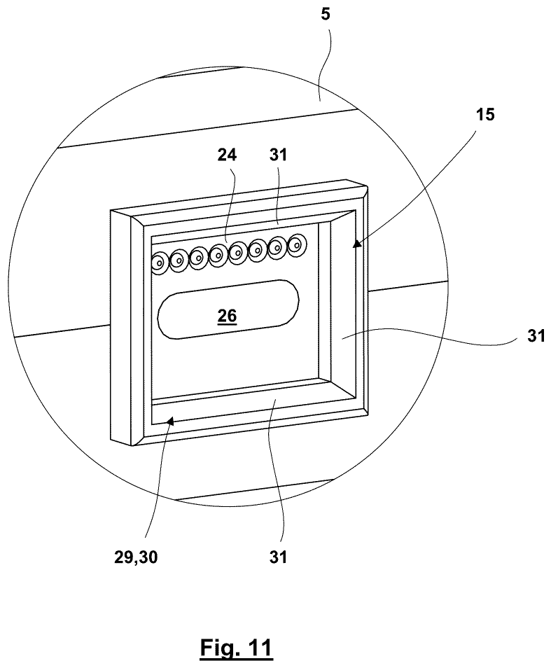

In FIG. 11 it can be seen that the plug socket 15 comprises an insertion support 29. For the embodiment shown, the insertion support 29 has a frame 30 surrounding the plug 11 in the inserted state, comprising insertion chamfers 31, the space between which tapers in the direction of insertion of the plug 10 to create a centering effect.

FIG. 13 shows a charging station 32, which can also be a stockage station 33 for pushable transport carts 3. The charging station 32 as shown in FIG. 13 provides electric power by means of a DC voltage. The charging station 32 comprises connectors 34, 35, 36. The connectors 34, 35 are used for the electric power supply and thus for charging the pushable transport carts 3 with electric energy. The other connector 36 forms an auxiliary contact that can be used, for example, to detect the (direct or indirect) connection of the pushable transport cart 3 to the charging station 32.

FIG. 13 shows a line 37 in which three pushable transport carts 3a, 3b, 3c are connected to each other in an electric series connection. In the operating position of the pushable transport cart system 38 formed in this way as shown in FIG. 13, the line 37 of pushable transport carts 3 is not connected to the charging station 32.

The pushable transport carts 3 are embodied as identical, at least with regard to the electric components.

The pushable transport carts 3 have input-side connectors 39, 40, 41 and output-side connectors 42, 43, 44. The input-side connectors 39, 40, 41 form a first electric connecting device 2-1, while the output-side connectors 42, 43, 44 form an output-side electric connecting device 2-2. An inlet side connecting device 2-1 of the pushable transport cart 3 can be connected to the connectors 34, 35, 36 of the charging station 32 or an outlet-side connecting device 2-2 of a neighboring pushable transport cart 3. However, it is also possible for a side referred to here as the “input side” to form an output side and vice versa, whereby it is also possible to change the input side to the output side and vice versa depending on the mode of operation.

In FIG. 13, the electric components of the pushable transport carts 3 are marked with reference numbers only for the pushable transport cart 3a, whereby the same applies to the other pushable transport carts 3. The connectors 42, 43, 44 and the electric connecting device 2-2 formed with them thus correspond to the connectors 34, 35, 36 and a correspondingly formed electric connecting device 45 of the charging station 32.

One of the connecting devices 2-1, 2-2 is embodied as a plug 10, while the other connecting device 2-2, 2-1 is embodied as a plug socket 15. In FIG. 13, for example, the connecting device 2-1 is embodied as a plug 10, while the other connecting device 2-2 is embodied as a plug socket 15 (while a reverse design is also possible).

The plug 10 and the plug socket 15 are connected to each other via a charge flow control unit 46, which is preferably an electronic control unit with control logic. The charge flow control unit 46 comprises a pass-through operating mode in which the plug 10 is connected to the plug socket 15. Furthermore, the charge flow control unit 46 may comprise a disconnected operating mode in which the plug 10 is disconnected from the plug socket 15. In particular, the disconnected operating mode can be a charging operating mode or there is an additional charging operating mode in which the plug 10 is disconnected from the plug socket 15, but the plug 10 is connected to a storage device 47 of the pushable transport cart 3 via the charge flow control unit 46. In this case, the connection between the charge flow control unit 46 and the storage device 47 can be made via a storage release device 48. The storage release device 48 can then have a release position in which the storage device 47 is connected to the charge flow control unit 46, which makes it possible to charge the storage device 47 via the charge flow control unit 46 or to use the charge of the storage device 47 to charge a storage device 47 of another pushable transport cart 3 via the charge flow control unit 46. Furthermore, the storage release device 48 has a disconnected position in which (as shown, at least one branch) between the storage device 47 and the charge flow control unit 46 is blocked.

A direction-determining current flow element 49, which is embodied as a diode 50 for the embodiment shown, can optionally be arranged between corresponding connectors 39, 42, which are connected to one another in the pass-through operating mode of the charge flow control unit 46. The current flow element 49 enables a charge flow from the charging station 42 by a pushable transport cart 3a (which can here also be denoted as a first pushable transport cart) to a neighboring pushable transport cart 3b (which can here also be denoted as a second pushable transport cart) arranged further away from the charging station 32, while an electric flow in the opposite direction is blocked.

Furthermore, a current sensor 51 is arranged between corresponding connectors 40, 43, which are connected to each other in the pass-through operating mode of the charge flow control unit 46.

Without this being absolutely necessary, the current flow element 49 on the one hand and the current sensor 51 on the other hand are arranged in different cable branches via which charging from the charging station 32 takes place for the embodiment according to FIG. 13.

The output signal of the current sensor 51 is fed to the storage release device 48. The current sensor 51 detects when a neighboring pushable transport cart 3b is connected to the pushable transport cart 3a of this current sensor 51, the charge flow control unit 46 is in the pass-through operating mode and thus current is transmitted via the electric connecting devices 2-2, 2-1 from the pushable transport cart 3a to the pushable transport cart 3b (or another pushable transport cart 3 of line 37). If such a current is transmitted, the supply of the output signal of the current sensor 51 to the storage release device 48 can be used to transfer the storage release device to the blocking position. If, on the other hand, it is detected that no neighboring pushable transport cart 3 is connected to the connector 43 of the pushable transport cart 3 or the charge flow control unit 46 of the neighboring pushable transport cart is in the charging operating mode, but in view of sufficient filling, the storage release device of the neighboring pushable transport cart 3b is in the disconnected position and therefore no current is flowing via the connector 43, the signal of the current sensor 51 can be used to transfer the storage release device 48 to the release position.

The (auxiliary) connectors 41, 44 can be used to detect whether the pushable transport cart 3 is connected to a charging station 32. This information can then be processed in the charge flow control unit 46 and/or the storage release device 48 in order to bring about the different operating modes and positions.

Preferably, the charge flow control unit 46 has a control output via which the charge flow control unit 46 is in a controlling connection (unidirectional or bidirectional) with the storage release device 48.

For the embodiment in FIG. 13, no charging of the line 37 can take place from the charging station 32 in view of the non-existent connection to the charging station 32. It is optionally possible for a pushable transport cart 3b, 3c (denoted here for example also as a second pushable transport cart) to be charged from a storage device 47 of a pushable transport cart 3a (denoted here for example also as a first pushable transport cart) arranged closer to the charging station 32.

If the line 37 is connected to the charging station 32, the pushable transport carts 3 in line 37 can be charged, whereby the operating modes and positions of the charge flow control unit 46 and the storage release devices 48 can be used to specify a charging sequence for the pushable transport carts 3a, 3b, 3c or to charge several or all of the storage devices 47 simultaneously. Preferably, the pushable transport cart 3c, which is furthest away from the loading station 32, is loaded first with higher prioritization, followed by successive loading of the pushable transport carts 3b, 3a in the order of decreasing distance from the loading station 32.

In FIG. 13, redundant detection of whether there is a connection to the charging station 32 is possible on the one hand by evaluating the signal at the connectors 41, 44 with the auxiliary line created above them to detect the charging station and on the other hand by evaluating the signal from the current sensor 51.

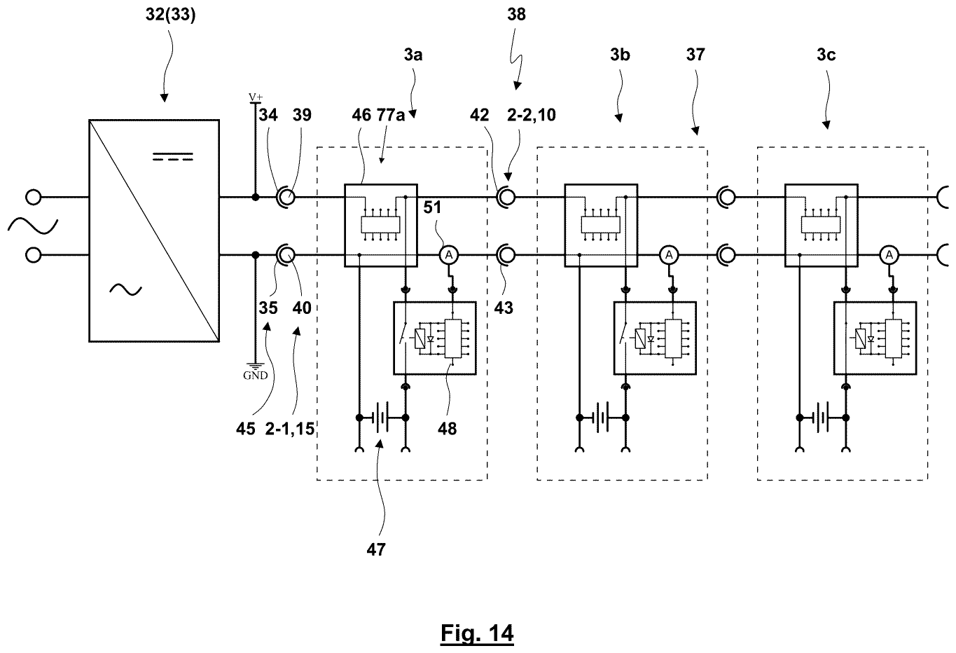

As FIG. 14 shows, an embodiment is also possible in which such an auxiliary line and thus the connectors 41, 44 are not present.

For the embodiment according to FIG. 14, the pushable transport carts 3 do not have a direction-determining current flow element 49. This comprises the fact that a charge flow is not exclusively possible in one direction, but is possible in both directions. This means that, depending on the operating modes and positions of the charge flow control units 46 and the storage release devices 48, it is possible for electric energy to be transferred from a storage device 47 of a more widely spaced pushable transport cart 3c to a pushable transport cart 3a, 3b arranged at a smaller distance from the charging station 32. Such a charge equalization in the line 37 can preferably be used to at least partially equalize the storage level of the storage units 47 of the line 37 if there is no connection with the charging station 32.

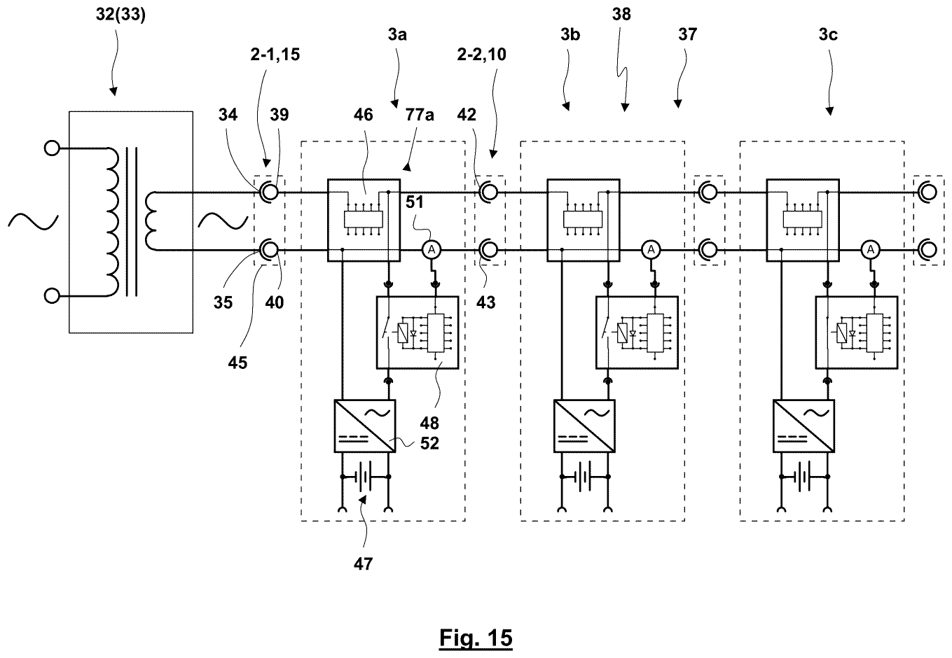

FIG. 15 shows an embodiment in which the charging station 32 provides an AC voltage rather than a DC voltage. In this case, an AC/DC voltage converter 52 is arranged upstream of the storage device 47, which in the charging operating mode produces the DC voltage required to charge the storage device 47.

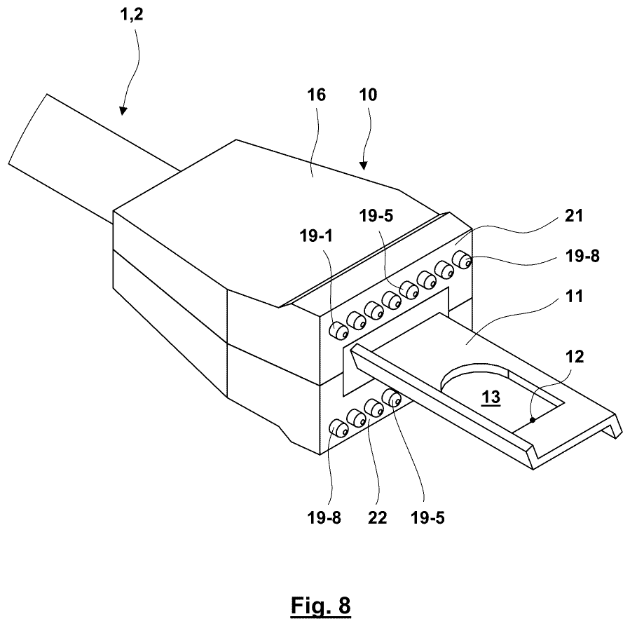

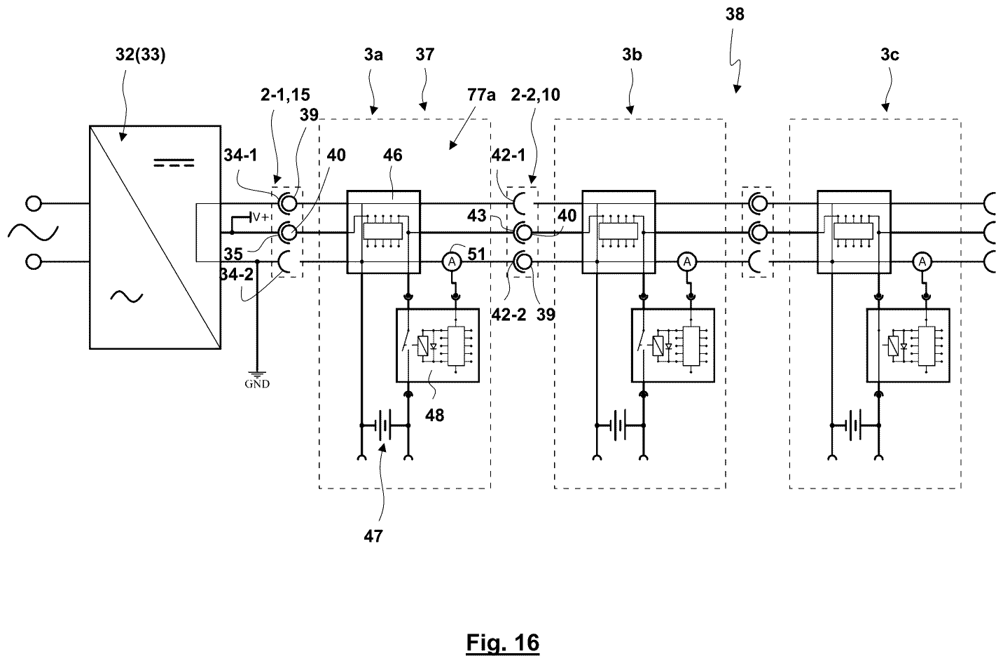

FIG. 16 shows an embodiment in which the electric connecting device of the charging station 32 and the electric connecting devices 2-2 of the pushable transport carts 3 comprise connections that are connected to each other and have the same voltage level on and are therefore redundant. These connections can then be integrated into different connector bars 21, 22 of a plug 10 (see FIG. 8) in order to enable the plug 10 to be inserted into the plug socket 15 in two different rotational positions around the longitudinal axis and protected against polarity reversal.

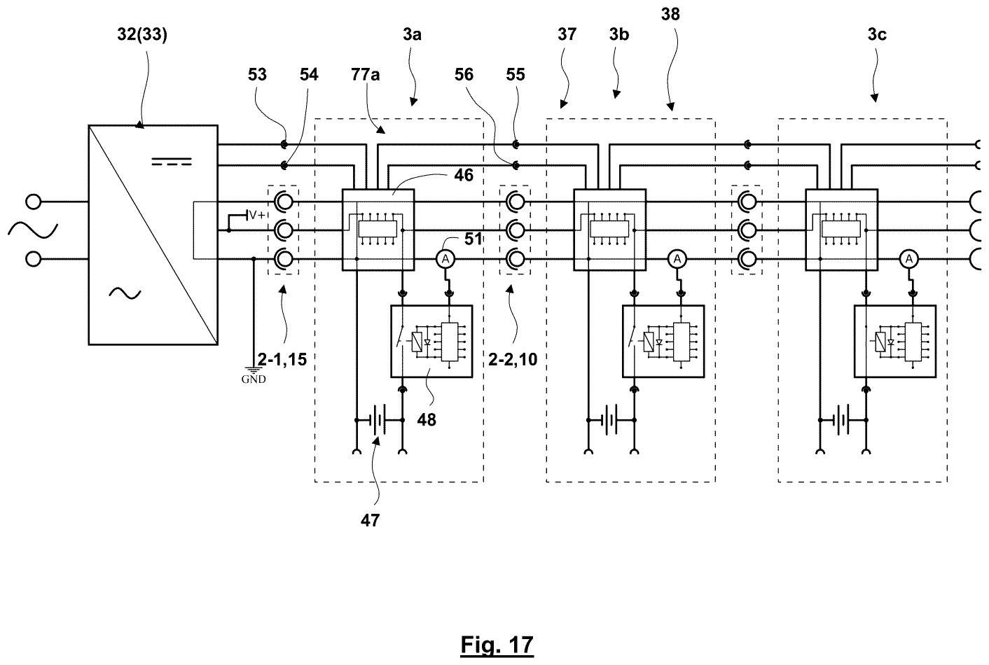

For the embodiment shown in FIG. 17, the connecting devices 2-1, 2-2 have further input-side connectors 53, 54 and output-side connectors 55, 56. These connectors 53, 54, 55, 56 form auxiliary contacts for the transmission of further signals. For example, the connectors 53, 54, 55, 56 can be connectors of data lines by means of which data can be transmitted between the pushable carts 3 and/or the charging station 32. This data can, for example, relate to a recorded charge status of a storage device 47. It is also possible that a specific identification of a pushable transport cart 3 is transmitted, which, for example, enables the number of pushable transport carts 3 in the line 37 connected to the charging station 32 to be determined.

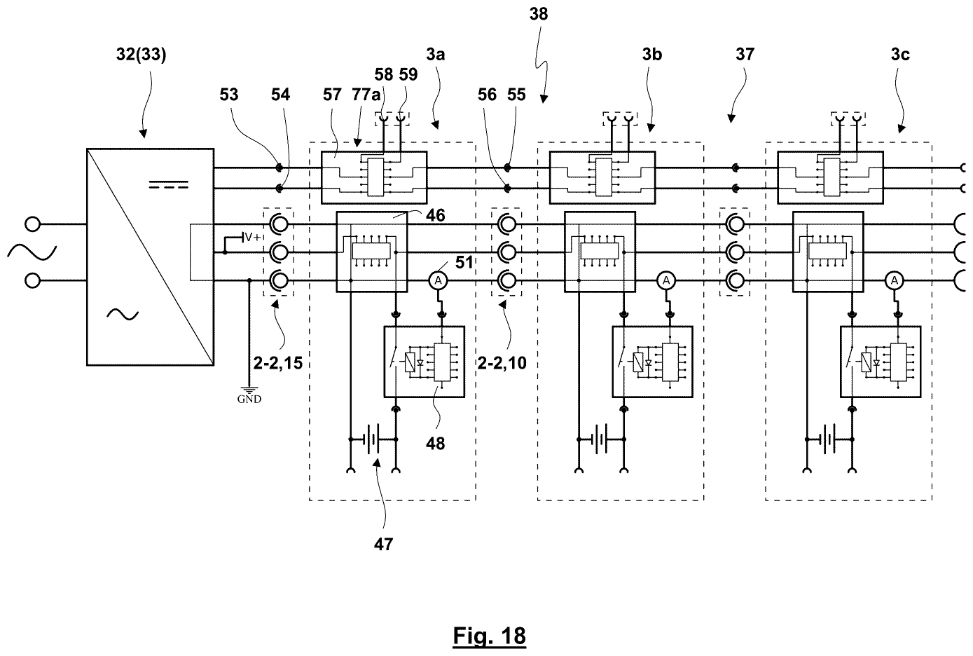

FIG. 18 shows that (in particular in the case of data transmission between the pushable transport carts 3 and/or the charging station 32 via connectors 53, 54, 55, 56) the pushable transport carts 3 each have a data processing unit 57, which is preferably an electronic control unit with control logic. The data processing unit 57 can process the transmitted data and coordinate sending and/or receiving the data, for example by using suitable data protocols. Furthermore, FIG. 18 shows that the pushable transport carts 3 can have further connectors 58, 59, which can be auxiliary contacts or—connectors. For example, sensors can be connected to the connectors 58, 59, in particular a temperature sensor or an acoustic sensor, which detects the rolling noise of the rollers of the pushable transport carts 3 to analyze in which area with a specific surface design a pushable transport cart 3 is currently moving. The connectors 58, 59 are preferably connected to the data processing unit 57.

It is possible that the direction-determining current flow element 49 can be bypassed by means of a bypass, whereby a switching device switched by a control unit can then be arranged in this bypass, which can activate or deactivate the bypass as required.

The charging station 32 can comprise any charging level, any charging power and any charging voltage. For example, the charging station 32 can be connected to a 230 V network and provide a DC voltage of 12 V. It is possible that the pushable transport cart 3 comprises a voltage converter that can increase or decrease the voltage level of the charging station 32. For the aforementioned charging station 32 with a 12 V power supply unit, the voltage can be increased by the voltage converter to a voltage level of 24 V, for example.

It is also possible that the charging station 32 has an electric storage device, buffer batteries and/or photovoltaic modules.

Instead of securing the pushable transport carts 3 to each other using a coin-operated lock 6, they can also be secured digitally. When using a customer-specific app, an unlocking process can be carried out by coupling with a wireless transmitting and/or receiving device, in particular a Bluetooth device. In extreme cases, the mechanical connecting device 1 can be reduced to the electric connecting device 2 and/or there is only a mechanical connection via a contact of permanent magnets 25, 26.

The at least one cable used in the connecting cord 7 should be highly flexible and/or capable of handling high currents.

The plug 10 and the plug socket 15 are ideally designed so that the connections are safe to touch and protected from environmental influences.

Preferably, the storage devices 47 are charged with a charging power of 50 watts, while the voltage at a pushable transport cart 3 can be 5 V, 12 V or 24 V (if necessary after a voltage conversion).

For one operating mode, the pushable transport cart system 38 can enable a pushable transport cart 3 that is charged or to be charged, which is furthest away from the charging station 32 in the line 37, to first be checked with regard to its charge status. If the storage device 47 is charged to at least a first threshold value (for example 70%), the charge flow control units 46 and the storage release device 48 are activated in such a way that this storage device 47 is charged. If, on the other hand, the charge status of the storage device 47 is greater than a second threshold value, which is less than the first threshold value (for example 30%), the charge flow control units 46 and the storage release devices 48 exclusively charge the storage device 47 by the charging station 32. If, on the other hand, the charge level of the storage device 47 falls below the second threshold value, the storage device 47 can be charged cumulatively by both the charging station 32 and the storage devices 47 of the pushable transport carts 3 arranged in the line 37 in front of and/or behind it, which represents a type of boost charging.

It is possible that the pushable transport cart 3 comprises an electric drive that replaces or supports a manual movement of the pushable transport cart 3. In this case, the drive system in one embodiment can also recuperate energy, which can then be fed to the storage device 47.

Sensors can be connected to the connections which comprise, for example
a load cell,
a position detection device (absolute like GPS; relative),
a temperature sensor for detecting whether the pushable transport cart 3 is located in a specific area of a supermarket, in particular a refrigerated area,
an acceleration sensor for detecting whether the pushable transport cart 3 is currently moving or stationary and how long it has been in a specific area of a supermarket and/or for detecting damaging operation of the pushable transport cart or even vandalism and/or for detecting a bumpy ride over a rough floor or in the area of tiles for indirect detection of an area in which the pushable transport cart 3 is being moved,
a brightness sensor to differentiate between day and night or to differentiate between shopping areas with different brightness levels or to control the brightness of a display depending on the ambient brightness,
a camera, a scanner, an RFID transmitting and/or receiving device or a scanner for a barcode or QR code and/or
a microphone

In this case, the connections for transmitting data and the data processing unit 57 can be arranged for processing and transmitting corresponding signals and data.

The pushable transport carts 3 can comprise displays, which can be any optical display, a red-yellow-green traffic light system or similar.

Furthermore, the pushable transport cart 3 can comprise control units, which can be, for example, a smartphone, switches, a keyboard, a touchscreen, a voice control, rotary controls and the like.

The pushable transport cart 3 can have a locking system or anti-theft system by means of which a wheel of the pushable transport cart 3 can be fixed or the securing chain 8 can be fixed.

It is also possible that the pushable transport cart system 38 has a latch in the area of the stockage station 33, which can be used to prevent the removal of pushable transport carts 3. In this case, a locking mechanism can be provided by a latch of the pushable transport cart 3 that is actuated by the pushable transport cart 3 itself. Alternatively or cumulatively, a latch of the stockage station 33 can interact with the pushable transport cart 3.

It is possible that a charging and stockage station 32, 33 enables two lines 37 of pushable transport carts 3 arranged next to each other, each of which can then be loaded via an associated charging station. Depending on the state of charge, the pushable transport carts 3 can then be preferentially charged in one of the two lines. In such a case, it is also possible for a user to be shown from which of the lines at the charging and stockage station 32, 33 a customer should remove a pushable transport cart 3. In particular, these are pushable transport carts 3 of line 37 comprising a higher loading status. This can be indicated to the customer on a central display of the charging and stockage station 32, 33 and/or on a display of the pushable transport carts 3.

It is possible that charging takes place exclusively via the connecting cord 7 of the pushable transport cart 3 or only partially, so that the circuit for charging requires both the establishment of the electric connection via the connecting cable 7 and additional contacting in another contact area of the pushable transport cart 3 or with a charging rail of the stockage station. This additional contact point can, for example, be located in the area of a shopping basket or a chassis of a shopping cart 4.

Data is transmitted using a serial protocol, for example.

A USP connector and/or a CAN bus can also be used.

It is possible that the data is transmitted in encrypted form.

It is possible that a separate line and assigned connections are available for data transmission. However, it is also possible for data to be transmitted via the charging power line by modulating the charging voltage and/or the charging current.

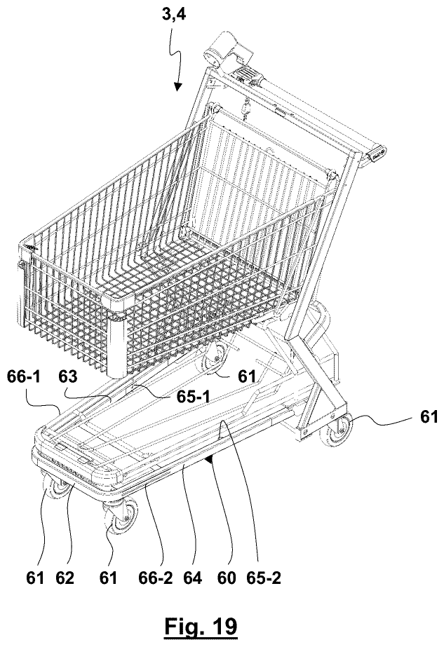

FIG. 19 shows a pushable transport cart 3 embodied as a shopping cart 4. The pushable transport cart 3 has a chassis frame 60 on which the vehicle wheels 61 are held (directly or indirectly). The chassis frame 60 is embodied as a U-shape with a front base leg 62 and diverging side legs 63, 64 extending rearwards from the base leg 62. The base leg 62 and the side legs 63, 64 can be formed by any frame profiles, in particular hollow profiles.

First contact elements 65 and second contact elements 66 are arranged on the inside and outside of the side legs 63, 62 respectively, whereby the contact elements 65, 66 are offset in the direction of the longitudinal axis of the side legs 63, 64.

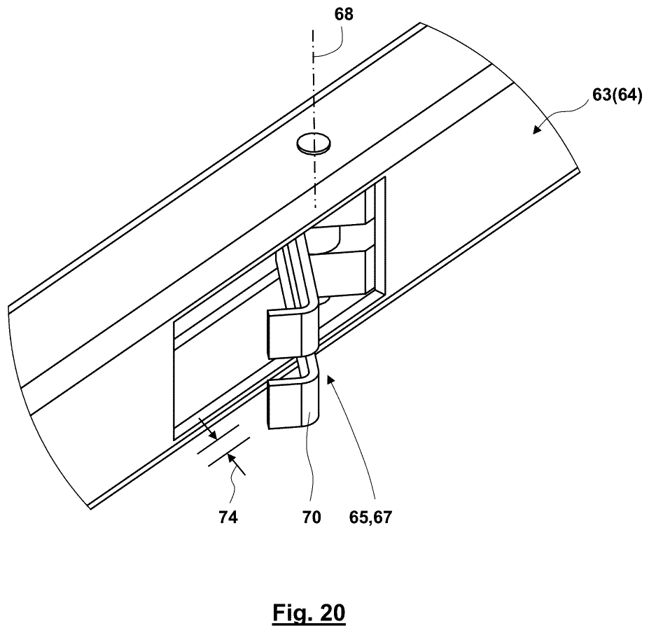

The contact element 65 is shown in detail in FIG. 20. It can be seen that the contact element 65 is embodied as a contact tongue 67. It is possible that the contact tongue 67 is embodied as elastic and thus ensures a compensating movement. Alternatively or cumulatively, the contact element 65 can be held movably on the side leg 63, 64 under the action of a spring device, which for the embodiment example shown in FIG. 20 is achieved by the contact element 65 or the contact tongue 67 being pivotably mounted on the side leg 63, 64 about a pivot axis 68, whereby the pivoting about the pivot axis 68 takes place under the action of a spring device. For the embodiment shown, the side leg 63, 64 has a window type opening to the interior, through which the contact tongue 67 on the inside of the side leg 63, 64 extends out of the latter.

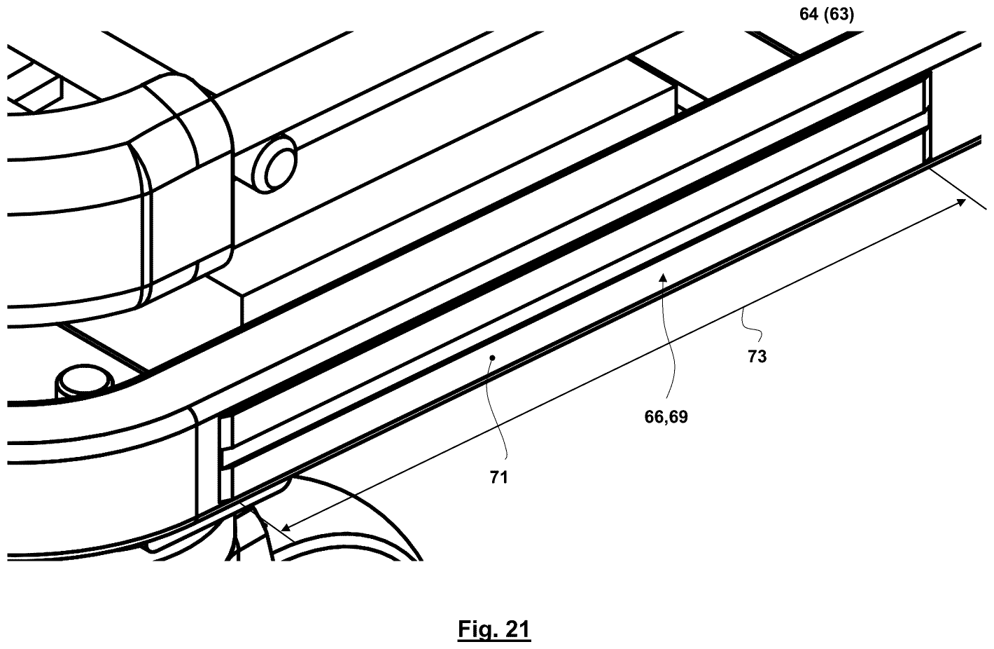

The contact element 66 is shown in detail in FIG. 21. Here, the contact element 66 is embodied as a contact slide bar 69.

The contact elements 65, 66 each form contact surfaces 70, 71, via which the contact elements 65, 66 come into contact with one another when the pushable transport carts 3 are pushed in and form an electric contact 72. The electric contact 72 is ensured in a compensation area, which is ensured in particular by the resilient support and/or a relative sliding movement of the contact elements 65, 66.

The length of the contact slide bar 69 provides a longitudinal compensation range 73, in the range of which the electric contact 72 is ensured. Furthermore, FIG. 20 shows a lateral compensation range 74 resulting from the possible deflection of the contact element 65.

For the embodiment shown, the contact elements 65, 66 are each provided in duplicate on the side legs 63, 64, whereby the duplicate contact elements can form redundant contact elements or can transmit separate signals or electric power separately.

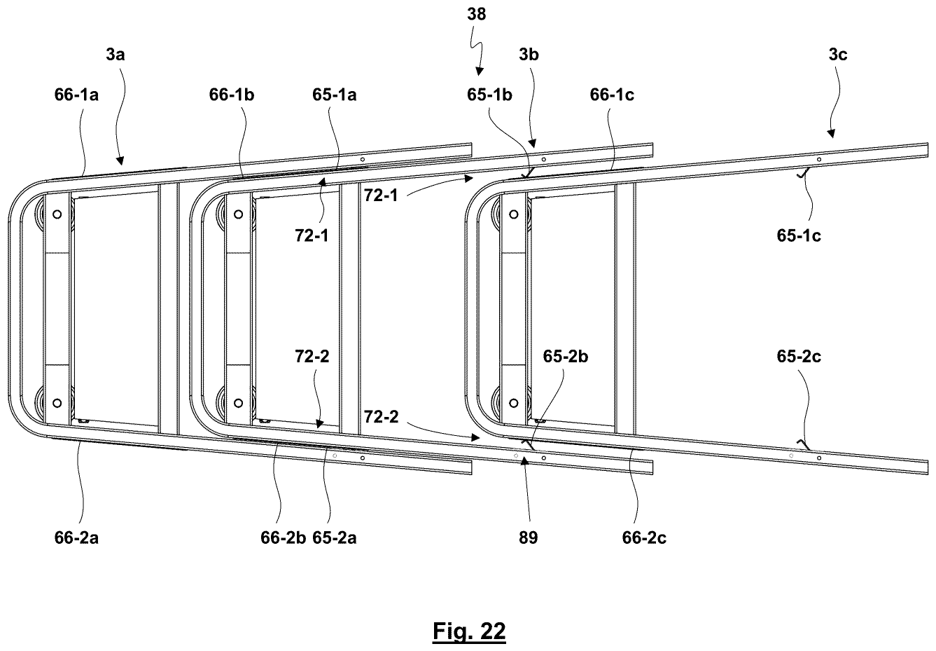

FIG. 22 shows a pushable transport cart system 38 with three pushable transport carts 3a, 3b, 3c. Here, the pushable transport cart 3b is pushed completely into the pushable transport cart 3a. The electric contact 72 in the area of the contact elements 65, 66 of the pushable transport carts 3a, 3b is ensured by the contact surface 70 of the contact element 65 in the rear end area resting against the contact surface 71 of the contact slide bar 69. In contrast, the pushable transport cart 3c is only partially pushed into the pushable transport cart 3b. This comprises that the contact surface 70 of the contact element 65 in the front end area is in contact with the contact surface 71 of the contact slide bar 69. If the pushable transport cart 3c were to be pushed further into the pushable transport cart 3b, the contact element 65 would slide further back along the contact surface 71 of the contact slide bar 69.

For the embodiment in FIGS. 19 to 22, the compensation ranges, in particular the longitudinal compensation range 73 and the lateral compensation range 74, are provided by a sliding degree of freedom and/or an elastic or resilient degree of freedom of the contact elements 65, 66, which extend in the horizontal plane. The contact force between the contact elements 65, 66 thus also comprises an orientation in the horizontal plane.

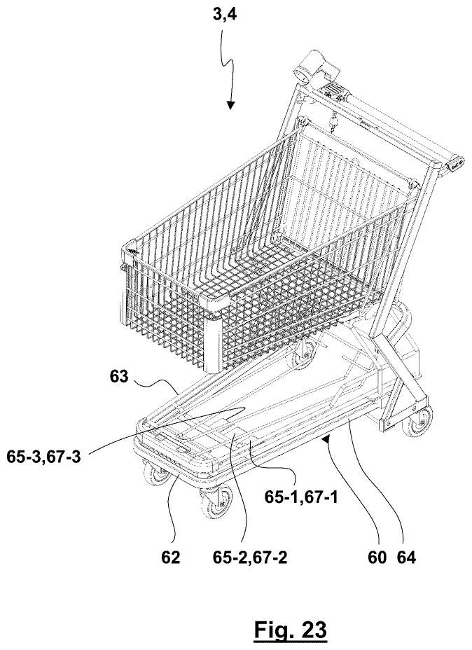

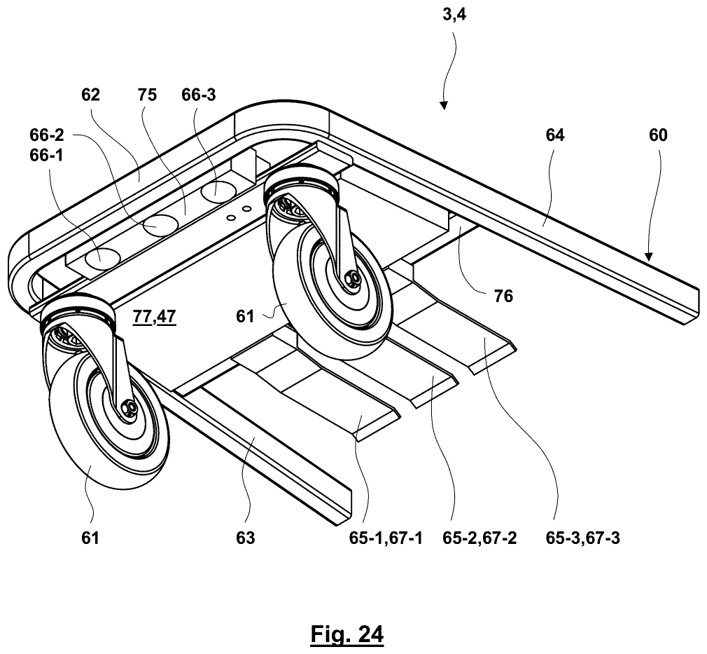

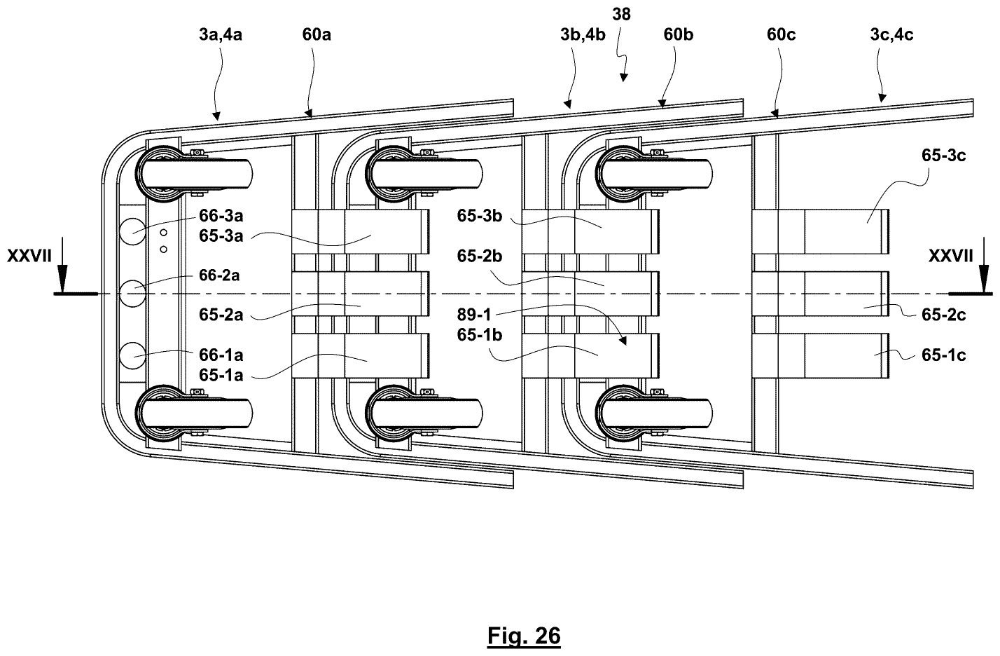

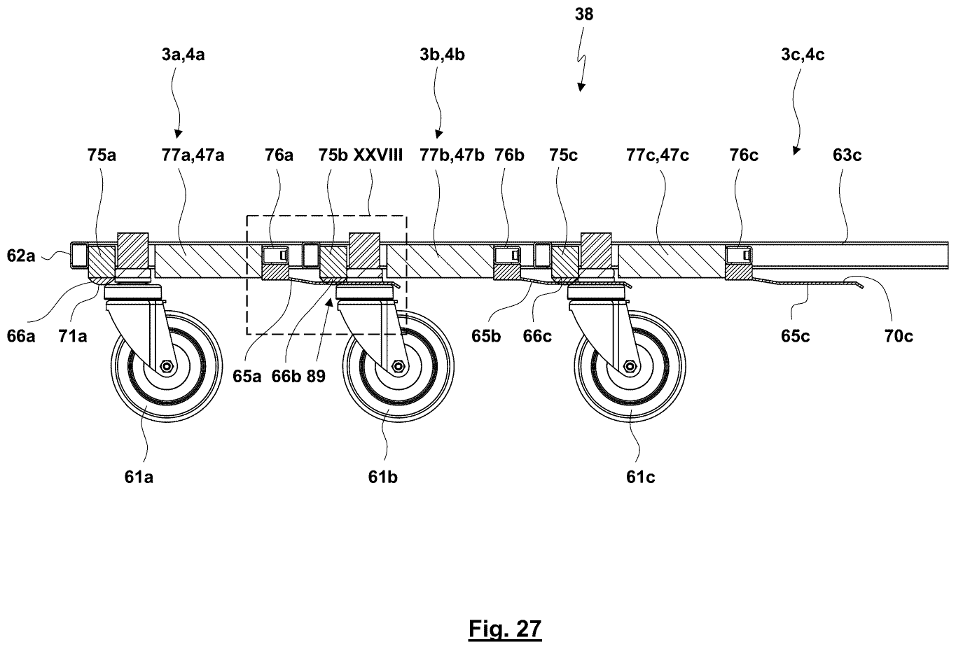

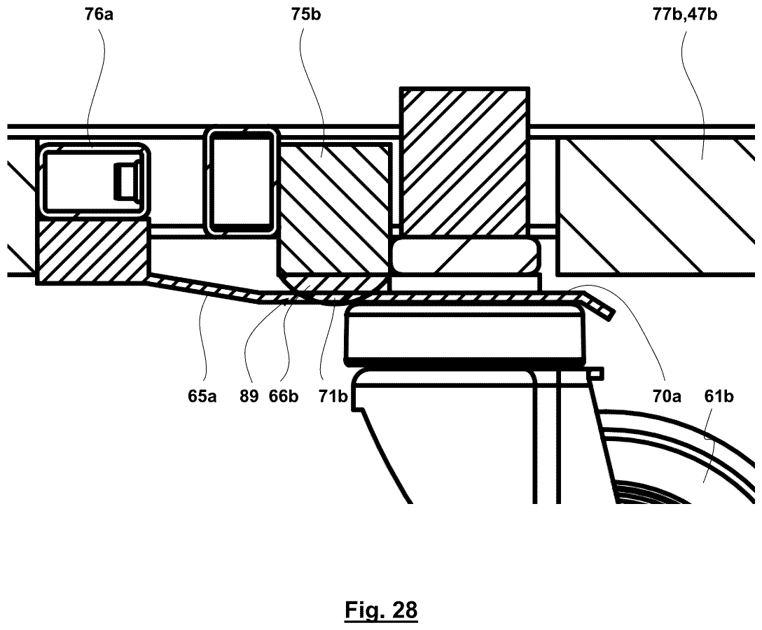

FIGS. 23 to 28 show an embodiment in which a contact force oriented in the vertical direction acts between the contact elements 65, 66. For this purpose, a vertically elastic contact element 66 is supported on the chassis frame 60, which is embodied as a vertically flexible contact tongue 67. Furthermore, the chassis frame 60 carries a contact element 65. In the embodiment shown, the contact element 65 points downwards. If the pushable transport cart 3b passes over the contact elements 66 of a pushable transport cart 3a arranged in front of it, the contact element 65b presses the contact tongue 67a of the pushable transport cart 3a arranged in front of it downwards, forming the electric contact 72.

For the embodiment shown, the pushable transport cart 3 has three contact elements 65-1, 65-2 and 65-3 arranged next to each other transversely to the longitudinal axis, which are embodied as contact tongues 67-1, 67-2 and 67-3 respectively. Here, the contact elements 66-1, 66-2 and 66-3 arranged next to each other are held on a contact element bar 75, which is attached directly to the base leg 62 on the inside. The contact tongues 67 are attached to a lateral strut 76, which is arranged at a distance from the base leg 62 and connects the two side legs 63, 64 to one another. It is possible that an electric device 77 and/or an electric storage device 47 are/is arranged between the base leg 62 and the contact element bar 75 on the one hand and the lateral strut 76 on the other side.

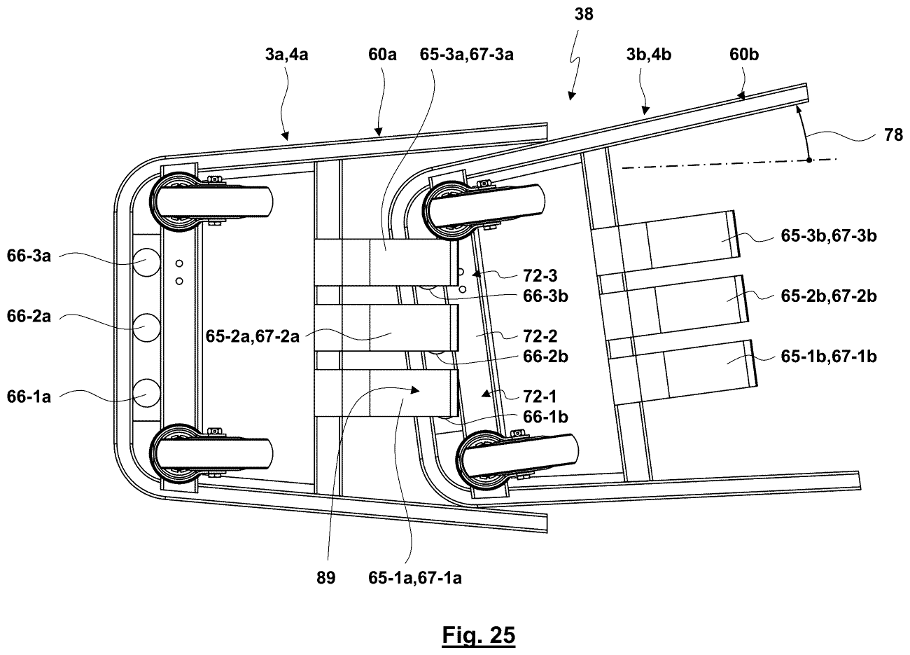

FIG. 25 shows a pushable transport cart system 38 in which two pushable transport carts 3a, 3b are only partially pushed into one another in the direction of their longitudinal axes, the longitudinal axes also not being aligned coaxially with one another. The contact elements 66-1b, 66-2b, 66-3b of the pushable transport cart 3b pass over the contact elements 65-1a, 65-2a and 65-3a, bringing about the electric contacts 72-1, 72-2 and 72-3. The design of the contact elements 65, 66 and the sliding contact of the same enables an angle compensation range 78 (in addition to a longitudinal compensation range and a lateral compensation range).

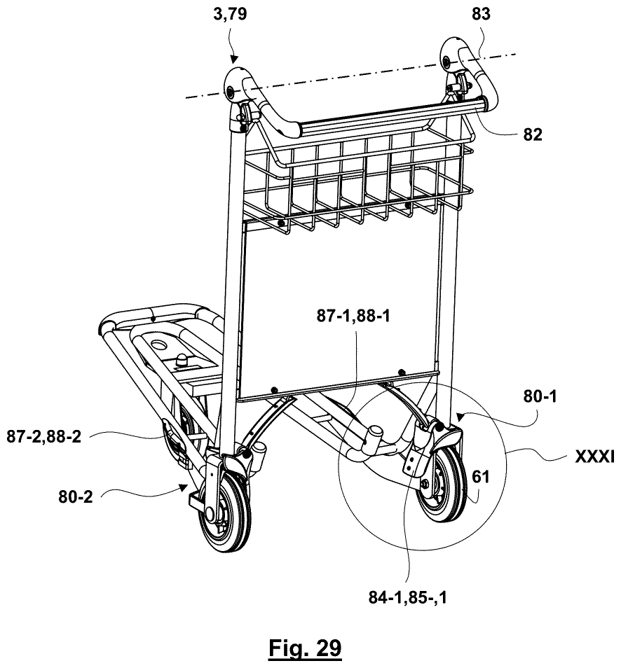

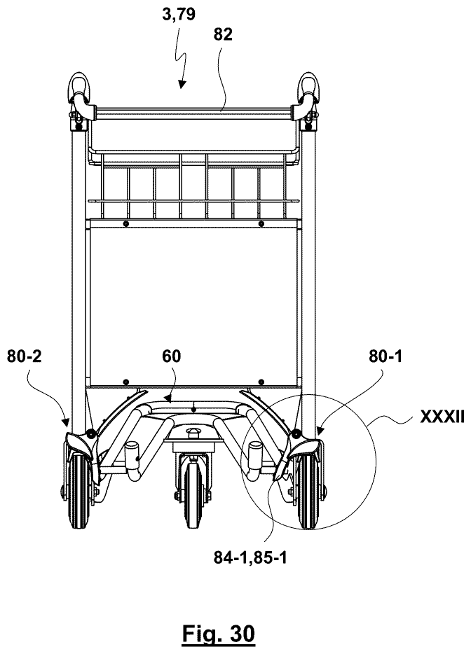

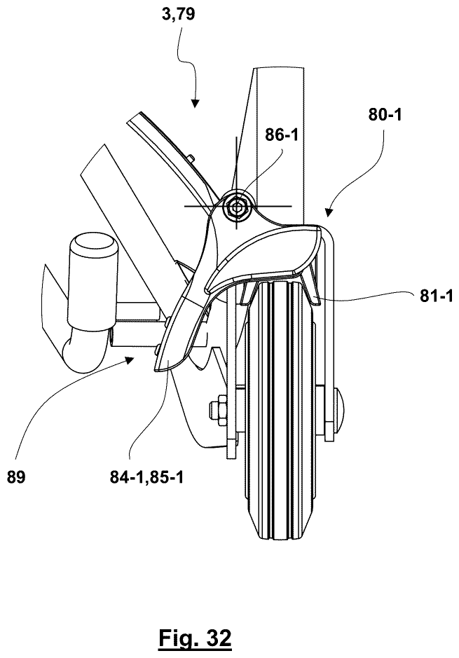

FIGS. 29 to 32 show a further embodiment of a pushable transport cart 3, here embodied as a baggage cart 79. The baggage cart 79 has a fixing brake 80 comprising a braking element 81, which is pressed against a vehicle wheel 61 in a parking position by means of a spring to produce a fixing brake effect (see FIG. 32). The baggage cart 79 has a pushrod 82. To enable the user to move the fixing brake 80 from the park position to a release position in which the braking element 81 is not pressed against the vehicle wheel 61, the user must swivel the pushrod 82 about a pivot axis 83 by pressing down the pushrod 82. The pivoting movement of the pushrod 82 about the pivot axis 83 is transmitted to the braking element 81 via a geared coupling connection, not shown here, in such a way that the braking element 81 is pivoted away from the vehicle wheel 61 by pressing down the pushrod 82. A spring device, also not shown here, acts on the pushrod 82, the coupling connection and the braking element 81 in the direction of the parking position, so that the spring device automatically brings about the parking position when the forces applied to the pushrod 82 by the user are removed.

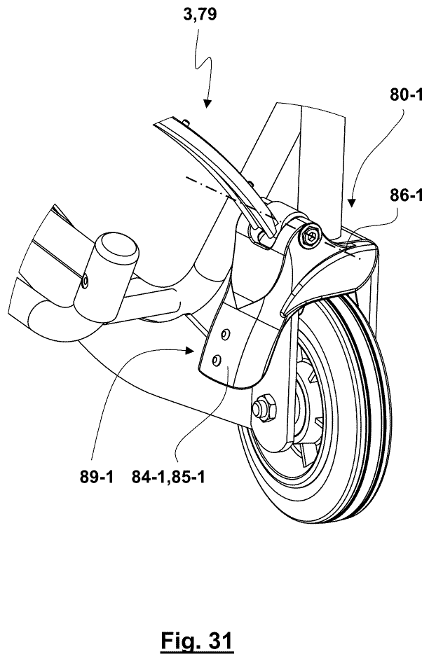

The fixing brake has an actuation element 84. The actuation element 84 is embodied as an actuation lever 85. The actuation lever 85 can be pivoted about a horizontal pivot axis 86, preferably oriented in the longitudinal direction. The spring device or an additional spring device presses the actuation lever 65 into an actuation lever parking position, which is assumed in FIGS. 31 and 32. If, on the other hand, a further pushable transport cart 3b is pushed into the pushable transport cart 3a from the rear, an outer surface of an associated side leg 63, 64 or an actuation element 87 held thereon, in particular a ramp-shaped slide bar 88, comes into contact with the actuation lever 85 and pushes the actuation lever 85 outwards, comprising a rotation of the actuation lever 85 about the pivot axis 86 in an anti-clockwise direction when viewed from the rear. The actuation lever 85 is geared to the braking element 81, whereby the braking element 81 can also be firmly connected to the actuation lever 85. The swivel movement of the actuation lever 85 as a result of the pushable transport cart 3 being pushed in, as explained above, therefore results in the braking element 81 being transferred from the park position to the release position. This can be accompanied by a movement of the geared coupling connection and the pushrod 82. Preferably, however, these retain their park position, which can be ensured by a degree of freedom or an elongated hole in the gear coupling connection. Further information on such an embodiment of a fixing brake automatically released with the insertion of a pushable transport cart as well as references to possible alternative embodiments of the realization of this fixing brake 80, which can also be used in the frame of the present invention, can be found in patent DE 2005 003 730 B4 of the applicant.

For this embodiment, the contact elements 65 can be arranged on the actuation element 84 or the actuation lever 85, while the contact elements 66 can be arranged on the actuation element 87 or the slide bar 88. The spring device of the fixing brake 80 is thus responsible both for bringing about the fixing braking effect of the fixing brake 80 and for providing the contact force between the contact elements 65, 66.

For the embodiment illustrated, two electric contacts 72-1, 72-2 are provided in this way between contact elements 65-1 and 66-1 and 65-2 and 66-2.

In the embodiments shown, a longitudinal compensation range 73, a lateral compensation range 74 and an angle compensation range 78 are provided in different ways by a compensating device 89. To give only a non-limiting example, these compensation ranges can be provided by the compensating device 89 on the one hand by a compliant design or support of the contact elements 65, 66 and/or by enabling a sliding movement of the contact elements 65, 66 relative to one another and/or a pivotable support of the contact elements 65, 66 against one another.

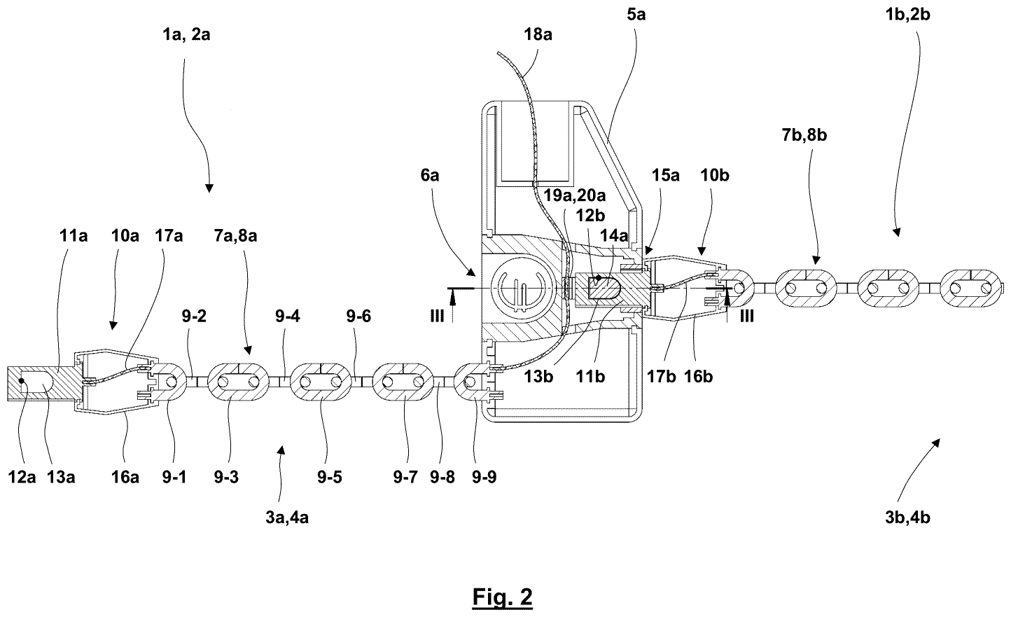

The possible transmissions of electric signals or electric power have previously been described for the use of the electric connecting device according to FIGS. 1 to 18 for the electric coupling of the pushable transport carts pushed into one another. The corresponding applies if the signals or power are not transmitted via the electric connecting device 45 and not via a plug 10 and a plug socket 15, but, as described with reference to FIGS. 19 to 32, via contact elements 65, 66. In this case, the control logic described, in particular for charge management, charging and the transmission of signals and electric power between several pushable transport carts in a line, can also be carried out accordingly via the contact elements 65, 66. The schematic diagrams according to FIGS. 13 to 18 also apply accordingly, whereby the contact elements 65, 66 can then be used instead of the electric connecting device 45, in particular the connectors 34, 35, 36, 39, 40, 41, 42, 43, 53, 54, 55, 56. All electric and electronic components, in particular the data processing unit 57, the charge flow control unit 46, the storage release device 48, the storage device 47, the current sensor 51, the current flow element 49 and/or the control logic described can then be used accordingly.

It is particularly advantageous for operational safety if the electric connecting devices, the plug, the plug socket and/or the contact element are de-energized or switched when a pushable transport cart is removed from another pushable transport cart in order to use the pushable transport cart.

Many variations and modifications may be made to the preferred embodiments of the invention without departing substantially from the spirit and principles of the invention. All such modifications and variations are intended to be included herein within the scope of the present invention, as defined by the following claims.

We claim:

1. A pushable transport cart system comprising at least a first pushable transport cart and a second pushable transport cart, the first and second pushable transport carts comprising an electric storage device and an electric device and two contact elements, the two contact elements establishing an electric contact in a movement-controlled manner by an insertion movement of the first and second pushable transport carts into one another, wherein a connection is established between an electric connecting device of the first pushable transport cart and an electric connecting device of the second pushable transport cart and/or a stockage and/or charging station, wherein control logic is provided which provides a charge flow management in which a storage device of the first pushable transport cart is charged from a storage device of the second pushable transport cart.

2. The pushable transport cart system of claim 1, wherein a chassis frame of the first and second pushable transport carts comprises a U-shaped frame structure comprising a front base leg and two rearwardly diverging side legs.

3. The pushable transport cart system of claim 1, wherein one of the contact elements comprises a downward-facing contact surface and the other contact element comprises an upward-facing contact surface.

4. The pushable transport cart system of claim 1, wherein at least one of the contact elements is adjustable with regard to
its position and/or
its orientation and/or
its elasticity and/or
its bias and/or
an elasticity or spring constant of a resilient support.

5. The pushable transport cart system of claim 1, wherein
the first and second pushable transport carts comprise a fixing brake which can be released via an actuation element, wherein the actuation element is biased by a spring device into a parking position in which the fixing brake is actuated, wherein the actuation element can be moved into a release position in a movement-controlled manner by an insertion movement of the first pushable transport cart into the second pushable transport cart against the bias by the spring device, and
at least one of the contact elements is arranged on the actuation element.

6. The pushable transport cart system of claim 1, with a mechanical connecting device, by which the first pushable transport cart can be mechanically connected to the second pushable transport cart and/or a stockage and/or charging station, wherein the mechanical connecting device and the first electric connecting device are combined and the mechanical connecting device and the first electric connecting device are configured in such a way that when the mechanical connecting device of the first pushable transport cart is mechanically connected to the mechanical connecting device of the second pushable transport cart or the stockage and/or charging station, at least one electric connection is created between the first electric connecting device of the first pushable transport cart and the first electric connecting device of the second pushable transport cart or the stockage and/or charging station, the at least one created electric connection serving for at least one of an electric power exchange, a signal exchange and a data exchange.

7. The pushable transport cart system of claim 6, wherein the first electric connecting device comprises redundant connectors, connector bars or interfaces, which can be used in different mounting orientations of the mechanical connecting device.

8. The pushable transport cart system of claim 6 comprising a further electric connecting device which is located at a distance from the first electric connecting device and the mechanical connecting device.

9. The pushable transport cart system of claim 6 comprising a storage release device, which in a release position connects the storage device to a power source by contact elements or the first or second electric connecting device in order to change a charge state of the storage device; and
in a disconnected position electrically isolates the storage device from the power source.

10. The pushable transport cart system of claim 1 comprising a charge flow control unit, the charge flow control unit
being connected between a plug and a plug socket or contact elements;
connecting the plug or the plug socket or the contact elements to the storage device;
in a pass-through mode of operation connecting the plug to the plug socket or the contact elements, but disconnecting the storage device from the plug or the plug socket or the contact elements, and
in a charging operating mode disconnecting the plug from the plug socket or the contact elements, but providing the connection of the storage device to the plug or the plug socket or the contact elements.

11. The pushable transport cart system of claim 1 comprising a stockage or charging station which is connected to the first and second pushable transport carts, the first and second pushable transport carts being connected to one another in a line.

12. The pushable transport cart system of claim 1 comprising control logic executing at least one of the following functions:
recognizing when the first pushable transport cart is mechanically and/or electrically connected to the second pushable transport cart, the stockage station or the charging station;
detecting or determining the number of the at least first and second pushable transport carts connected in a line to each other or to the stockage station or to the charging station; and
controlling an exchange of electric energy between the at least first and second pushable transport carts that are connected to each other but not to the stockage or charging station.

13. The pushable transport cart system of claim 1 comprising control logic providing at least one of the following functions:
executing a charge flow management which takes into account a loading quantity specific to a supermarket or a baggage transportation area;
executing the charge flow management in which a demand parameter specific to a supermarket, a baggage transportation area, a time or a day of the week is taken into account, the demand parameter correlating with an expected demand of the at least first and second pushable transport carts used by the customers per time unit;
executing the charge flow management, in which in the line of the at least first and second pushable transport carts connected to the stockage station or the charging station first the pushable transport cart of the at least first and second pushable transport carts furthest away from the stockage and/or charging station is charged until a threshold value of the charging status is reached, and then successively the with regard to the direction of the stockage station or the charging station neighboring pushable transport cart of the at least first and second pushable transport carts is charged; and
executing the charge flow management, in which charging of the storage device of the first pushable transport cart takes place both from the storage device of the second pushable transport cart as well as from the charging station.

14. The pushable transport cart system of claim 1 comprising control logic which detects at least one of the following:
a separation of the first pushable transport cart from the second pushable transport cart or from the stockage station or the charging station;
a separation of the mechanical connecting device of the first pushable transport cart from the mechanical connecting device of the other pushable transport cart or from the stockage station or from the charging station; or
a separation of the electric connecting devices of the first pushable transport cart from the electric connecting device of the second pushable transport cart or from the stockage station or from the charging station.

15. The pushable transport cart system of claim 14 comprising control logic which in response to detecting on the basis of a signal from a sensor that a shopping product or an object of the user is still on the first or second pushable transport cart and not detecting a separation, the system provides the user with information that a shopping product or an object of the user is still on the first or second pushable transport cart.
